(19) United States
(12) Patent Application Publication
(10) Pub. No.: US 2026/0297314 A1
(43) Pub. Date: Oct. 1, 2026

(54) COMPOSITE MATERIAL CONTAINING CELLULOSE FIBERS AND HAVING HIGH IMPACT STRENGTH

(71) Applicant: BOREALIS GMBH, Vienna (AT)

(72) Inventors: Thomas Lummerstorfer, Linz (AT); Claudia Pretschuh, Pasching (AT); Jürgen Lesslhumer, Geboltskirchen (AT); Lukas Sobczak, Linz (AT); Markus Gahleitner, Linz (AT); Georg Grestenberger, Linz (AT)

(21) Appl. No.: 19/481,645

(22) PCT Filed: May 7, 2024
(86) PCT No.: PCT/EP2024/062512

§ 371 Date: Nov. 5, 2025

(30) Foreign Application Priority Data
May 8, 2023 (EP) 23172049.1

(51) Int. Cl. C08L 23/16; C08L 1/02

(52) U.S. Cl. CPC C08L 23/16; C08L 1/02; C08L 2205/025

(57) ABSTRACT

A composite material is provided being obtainable by blending the components (a) to (g), and optionally component (h): (a) from 10.0 to 35.0 wt.-% of a first heterophasic propylene-ethylene copolymer (HECO1), (b) from 5.0 to 25.0 wt.-% of a second heterophasic propylene-ethylene copolymer (HECO2), (c) from 8.0 to 40.0 wt.-% of a mixed-plastic polypropylene blend; (d) from 8.0 to 18.0 wt.-% of an ethylene-based elastomer, (e) from 5.0 to 30.0 wt.-% of cellulose-containing fibers, (f) from 1.0 to 5.0 wt.-% of a compatibilizer, (g) from 0.1 to 5.0 wt.-% of additives, (h) optionally from 0.1 to 15.0 wt.-% of a high density polyethylene, wherein the weight amounts of components (a) to (h) are defined relative to the total weight of the composite material. Further, an injection molded article is provided comprising the composite material.

### TECHNICAL FIELD

The present invention relates to a composite material comprising polymers and cellulose-containing fibers. The composite material may be used for preparing injection molded articles, like injection molded articles for the automotive sector.

### BACKGROUND OF INVENTION

Polymer compositions that are reinforced with inorganic fiber or filler, like glass fiber or talc, are well-known in the art. Said materials are typically used for manufacturing, for example in the automotive industry, due to their good balance in terms of strength and stiffness, on the one hand, and impact properties on the other.

There is a continuing effort in the art, and particularly in the automotive industry, to increase the content of renewables in reinforced polymer compositions in order to save non-renewable resources and/or decrease a carbon dioxide footprint of said materials. One possible approach for increasing the renewable content in reinforced polymer compositions is by using fibrous materials from natural sources. However, developments in said direction have so far only provided composite materials that show a comparatively low impact strength and/or a stiffness and impact strength which is not balanced in a way as it is desired in the art.

Furthermore, many manufacturers, like original equipment manufacturers in the automotive industry, aim at using recycled materials for their products to further increase efforts to save non-renewable resources and/or decrease a carbon dioxide footprint when manufacturing their goods. Therefore, there is also a challenge in the art to provide composite materials and a recyclate content (in addition to a renewable content) while still achieving adequate functionality, like a good balance of mechanical properties.

EP 1580231 A1 describes a polypropylene composite that comprises a propylene homo- or co-polymer reinforced by a cellulose-containing natural material and containing a graft-carboxylated propylene homo- or co-polymer as an adhesive aid. EP 2551299 A1 is directed to a composition comprising a heterophasic polymer composition and at least one cellulose based filler, wherein the heterophasic polymer composition comprises a propylene homo- and/or copolymer matrix phase and an elastomeric propylene copolymer which is dispersed in said matrix phase. US 2015/0252179 A1 relates to a polyolefin-natural fiber composite composition for extrusion molding, and more particularly to a polyolefin-natural fiber composite composition, which comprises polyolefin resin, natural fiber, thermoplastic elastic rubber and an anhydrous maleic acid-grafted polypropylene-based compatibilizer.

It is desired in the art to provide a composite material based on a polymer matrix and a renewable reinforcing agent that combines a high impact strength with a good level of stiffness. Further, the composite material should have a comparatively low density. It is further desirable to incorporate a significant amount of recyclate into such composite materials.

One object of the present invention is to provide a composite material containing fiber from a natural source and having good mechanical properties, like a good balance between strength and stiffness, on the one hand, and impact strength on the other hand. Another object of the present invention can be seen in the provision of a composite material containing fiber from a natural source and a recyclate content, while achieving good mechanical properties, like a good balance between strength and stiffness, on the one hand, and impact strength on the other hand.

### SUMMARY OF INVENTION

One or more of the foregoing objects is solved by the subject-matter of the appended claims. In one aspect of the present invention, a composite material is provided. The composite material is obtainable by blending the components (a) to (g), and optionally component (h):
(a) from 10.0 to 35.0 wt.-% of a first heterophasic propylene-ethylene copolymer (HECO1) having a melt flow rate (MFR₂), determined according to ISO 1133 at 230° C. and 2.16 kg, in the range from 60 to 200 g/10 min,
(b) from 5.0 to 25.0 wt.-% of a second heterophasic propylene-ethylene copolymer (HECO2) having
a melt flow rate (MFR₂), determined according to ISO 1133 at 230° C. and 2.16 kg, in the range from 4 to 30 g/10 min, and
a soluble fraction (SF), determined according to CRYSTEX QC analysis, in the range from 17.0 to 40.0 wt.-%, relative to the total weight of the second heterophasic propylene-ethylene copolymer (HECO2),
(c) from 8.0 to 40.0 wt.-% of a mixed-plastic polypropylene blend having a polypropylene content of at least 75 wt.-%, based on the total weight of the mixed-plastic polypropylene blend;
(d) from 8.0 to 18.0 wt.-% of an ethylene-based elastomer being a copolymer of ethylene and an alpha-olefin co-monomer having from 4 to 12 carbon atoms, and the ethylene-based elastomer having a density in the range of 850 to 900 kg/m³,
(e) from 5.0 to 30.0 wt.-% of cellulose-containing fibers,
(f) from 1.0 to 5.0 wt.-% of a compatibilizer being a polar modified polypropylene or a polar modified elastomer,
(g) from 0.1 to 5.0 wt.-% of additives,
(h) optionally from 0.1 to 15.0 wt.-% of a high density polyethylene, wherein the weight amounts of components (a) to (h) are defined relative to the total weight of the composite material.

It has surprisingly been found that the composite material provides for a good balance between strength and stiffness, on the one hand, and impact strength on the other hand. The composite material has a low density, and contains a significant amount of wood-based fiber providing the composite material with a desirable renewable content. Furthermore, the presence of a mixed-plastic polypropylene blend, like a post-consumer recyclate, does not influence or only moderately influences the properties of the composite material, when compared to a comparable material not containing this component. Good surface properties, like scratch resistance and mar resistance, can also be achieved by the composite material.

In one embodiment, the composite material has one or both, preferably both, of the following characteristics:
a melt flow rate (MFR₂), determined according to ISO 1133 at 230° C. and 2.16 kg, in the range from 8 to 80 g/10 min, preferably in the range of 9 to 75 g/10 min, more preferably in the range of 10 to 70 g/10 min, and even more preferably 10 to 60 g/10 min; and
a density of less than 1000 kg/m³, and preferably in the range of 900 to 990 kg/m³.

In one embodiment, the composite material has the following characteristics:
a flexural modulus, determined according to ISO 178, of at least 1100 MPa, preferably at least 1150 MPa, and more preferably at least 1200 MPa, optionally the upper limit being 2000 MPa; and
a Charpy Notched impact strength at 23° C., determined according to ISO 179 1 eA, of at least 7.0 kJ/m², preferably at least 8.5 kJ/m², and more preferably at least 11.0 kJ/m², optionally the upper limit being 45 kJ/m².

In one embodiment, the composite material is obtainable by blending the components (a) to (h):
(a) from 11.0 to 32.0 wt.-%, preferably from 12.0 to 30.0 wt.-%, and more preferably from 13.0 to 29.0 wt.-%, of the first heterophasic propylene-ethylene copolymer (HECO1),
(b) from 7.0 to 23.0 wt.-%, preferably from 8.0 to 21.0 wt.-%, and more preferably from 9.0 to 20.0 wt.-%, of the second heterophasic propylene-ethylene copolymer (HECO2),
(c) from 10.0 to 37.0 wt.-%, preferably 12.0 to 35.0 wt.-%, and more preferably 13.0 to 33.0 wt.-%, of the mixed-plastic polypropylene blend,
(d) from 9.0 to 17.0 wt.-%, preferably from 10.0 to 16.0 wt.-%, and more preferably from 10.0 to 14.0 wt.-%, of the ethylene-based elastomer,
(e) from 8.0 to 28.0 wt.-%, preferably from 10.0 to 26.0 wt.-%, and more preferably from 12.0 to 22.0 wt.-%, of the cellulose-containing fibers,
(f) from 1.0 to 5.0 wt.-%, preferably from 1.5 to 4.5 wt.-%, and more preferably from 2.0 to 4.0 wt.-%, of the compatibilizer,
(g) from 0.5 to 5.0 wt.-%, preferably 1.0 to 5.0 wt.-%, and more preferably 2.0 to 5.0 wt.-%, of the additives,
(h) from 1.0 to 15.0 wt.-%, preferably from 2.0 to 12.0 wt.-%, and more preferably from 5.0 to 11.0 wt.-%, the high density polyethylene,
wherein the weight amounts are relative to the total weight of the composite material, and optionally wherein the weight amounts add up to at least 98.0 wt.-%, preferably at least 99.0 wt.-%, and more preferably to 100.0 wt.-%.

In one embodiment, the first heterophasic propylene-ethylene copolymer (HECO1) has one or both, preferably both, of the following characteristics:
a soluble fraction (SF) content, determined according to CRYSTEX QC analysis, in the range from 6.0 to 22.0 wt.-%, preferably 8.0 to 20.0 wt.-%, and more preferably 10.0 to 19.0 wt.-%, relative to the total weight of the first heterophasic propylene-ethylene copolymer (HECO1); and
an intrinsic viscosity, determined according to DIN ISO 1628/1, of the soluble fraction content (iV(SF)), according to CRYSTEX QC analysis, in the range from 1.5 to 3.5 dL/g, preferably 1.7 to 3.3 dL/g, and more preferably 1.8 to 3.2 dL/g.

In one embodiment, the second heterophasic propylene-ethylene copolymer (HECO2) has one or both, preferably both, of the following characteristics:
a melt flow rate (MFR₂), determined according to ISO 1133 at 230° C. and 2.16 kg, in the range from 4 to 25 g/10 min, preferably from 4 to 20 g/10 min, and more preferably from 5 to 15 g/10 min; and
an intrinsic viscosity, determined according to DIN ISO 1628/1, of the soluble fraction content (iV(SF)), according to CRYSTEX QC analysis, in the range from 2.0 to 7.0 dL/g, preferably from 2.5 to 6.8 dL/g, and more preferably from 3.5 to 6.5 dL/g.

In one embodiment, the second heterophasic propylene-ethylene copolymer (HECO2) has at least one, preferably at least two, and more preferably all, of the following characteristics:
a soluble fraction (SF), determined according to CRYSTEX QC analysis, in the range from 18.0 to 38.0 wt.-%, preferably 19.0 to 35.0 wt.-%, and more preferably 19.0 to 33.0 wt.-%, relative to the total weight of the second heterophasic propylene-ethylene copolymer (HECO2);
a soluble fraction (SF) having an ethylene content (C2(SF)) determined by FT-IR spectroscopy calibrated by quantitative ¹³C-NMR spectroscopy, in the range from 20.0 to 50.0 wt.-%, preferably in the range from 20.0 to 45.0 wt.-%, and more preferably in the range from 21.0 to 40.0 wt.-%, relative to the total weight of the soluble fraction (SF) of the second heterophasic propylene-ethylene copolymer (HECO2); and
a ratio of the intrinsic viscosity of the soluble fraction content (iV(SF)), according to CRYSTEX QC analysis, to the intrinsic viscosity of the crystalline fraction (iV(CF)), according to CRYSTEX QC analysis, in the range of from 1.2 to 6.0, preferably from 1.5 to 5.0, and more preferably in the range of 2.0 to 4.0, the intrinsic viscosity being determined according to DIN ISO 1628/1.

In one embodiment, the mixed-plastic polypropylene blend has a limonene content, determined by solid phase microextraction (HS-SPME-GC-MS), of at least 0.10 ppm, and preferably in the range from 0.10 to 25.0 ppm.

In one embodiment, the mixed-plastic polypropylene blend has at least one, preferably at least two, more preferably at least three, and even more preferably all, of the following characteristics:
a melt flow rate (MFR₂), determined according to ISO 1133 at 230° C. and 2.16 kg, in the range from 2 to 70 g/10 min, preferably from 5 to 40 g/10 min, and more preferably from 8 to 35 g/10 min;
a soluble fraction (SF) content in the range from 4.0 to 16.0 wt.-%, preferably 6.0 to 14.0 wt.-%, and more preferably 8.0 to 12.0 wt.-%, relative to the total weight of the mixed-plastic polypropylene blend, and a crystalline fraction (CF) content in the range from 84.0 to 96.0 wt.-%, preferably 86.0 to 94.0 wt.-%, and more preferably 88.0 to 92.0 wt.-%, relative to the total weight of the mixed-plastic polypropylene blend, both fractions determined according to CRYSTEX QC analysis;
a crystalline fraction (CF) having an ethylene content (C2 (CF)), determined by FT-IR spectroscopy calibrated by quantitative ¹³C-NMR spectroscopy, in the range from 1.0 to 12.0 wt.-%, preferably in the range from 1.5 to 10.0 wt.-%, and more preferably in the range from 2.0 to 9.0 wt.-%, relative to the total weight of the crystalline fraction (CF) of the mixed-plastic polypropylene blend;
an intrinsic viscosity of the soluble fraction (iV(SF)), according to CRYSTEX QC analysis, determined according to DIN ISO 1628/1, in the range from 0.90 to 2.2 dL/g, preferably from 1.1 to 2.1 dL/g, and more preferably from 1.3 to 2.0 dL/g; and
a polypropylene content in the range of from 80 to 99 wt.-%, preferably from 83 to 96 wt.-%, based on the total weight of the mixed-plastic polypropylene blend.

In one embodiment, the ethylene-based elastomer has a density in the range of 855 to 895 kg/m³, and having a melt flow rate (MFR₂), determined according to ISO 1133 at 190° C. and 2.16 kg, in the range from 0.5 to 30 g/10 min.

In one embodiment, the ethylene-based elastomer is a copolymer of ethylene and an alpha-olefin co-monomer having from 4 to 8 carbon atoms, and preferably being a copolymer of ethylene and 1-octene.

In one embodiment, the compatibilizer is a polar modified propylene homo- or copolymer, and optionally wherein the polar modified propylene homo- or copolymer is a propylene homo- or copolymer grafted with maleic anhydride and/or acrylic acid.

In one embodiment, the cellulose-containing fibers have one or both, preferably both, of the following characteristics:
a weight-based average fiber length in the range of 0.10 to 2.0 mm, preferably in the range of 0.15 to 1.50 mm, and more preferably in the range of 0.30 to 1.20 mm; and
a weight-based average aspect ratio of at least 1.5, preferably at least 1.8, and more preferably at least 2.2.

In one embodiment, the high density polyethylene has a density in the range of 945 to 965 kg/m³, and optionally a melt flow rate (MFR₂), determined according to ISO 1133 at 190° C. and 2.16 kg, in the range from 0.5 to 30 g/10 min.

Another aspect of the present invention relates to an injection molded article comprising the composite material as defined herein.

### Definitions

A “propylene homopolymer” is a polymer that essentially consists of propylene monomer units. Due to impurities especially during commercial polymerization processes, a propylene homopolymer can comprise up to 0.1 mol % comonomer units, preferably up to 0.05 mol % comonomer units and most preferably up to 0.01 mol % comonomer units.

A “propylene copolymer” is a copolymer of propylene monomer units and comonomer units, preferably selected from ethylene and C₄-C₈ alpha-olefins, and more preferably one type of comonomer units selected from ethylene and C₄-C₈ alpha-olefins. A “propylene random copolymer” is a propylene copolymer wherein the comonomer units are randomly distributed along the polymer chain, whilst a “propylene block copolymer” comprises blocks of propylene monomer units and blocks of comonomer units. Propylene random copolymers can comprise comonomer units from one or more comonomers different in their amounts of carbon atoms.

A “heterophasic propylene-ethylene copolymer” comprises a crystalline matrix phase and an elastomeric phase being dispersed in said matrix phase. Said crystalline matrix phase may be a propylene homopolymer or a random copolymer of propylene and ethylene. Said elastomeric phase is typically a propylene-ethylene copolymer with a high amount of ethylene comonomer that is not randomly distributed in the polymer chain but is distributed in a comonomer-rich block structure and a propylene-rich block structure. A heterophasic propylene copolymer usually differentiates from a one-phasic propylene copolymer, for example, in that it shows two distinct glass transition temperatures Tg which are attributed to the matrix phase and the elastomeric phase.

The term “mixed-plastic polypropylene blend” relates to a plastic blend predominantly comprising polypropylene; however, minor amounts of other plastics are present, typically the other plastics comprise at least polyethylene. The mixed-plastic polypropylene blend is typically a recycled material. The term “recycled material” as used herein denotes materials reprocessed from “recycled waste”. Recycled waste or recycled waste streams, which are high in polypropylene can be obtained, for example, from the automobile industry, particularly as some automobile parts such as bumpers are sources of fairly pure polypropylene material in a recycling stream.

For the purposes of the present disclosure the term “recycled waste” is used to indicate a material recovered from both post-consumer waste and industrial waste, as opposed to virgin polymers. “Post-consumer waste” refers to objects having completed at least a first use cycle (or life cycle), i.e. having already served their first purpose; while “industrial waste” refers to manufacturing scrap, which does not normally reach a consumer. On the other hand, the term “virgin” denotes the newly produced materials and/or objects prior to their first use, which have not already been recycled. Recycled waste, like post-consumer waste, can typically be identified by the presence of low amounts of compounds usually not found in virgin materials (e.g., virgin polypropylene materials) such as polystyrenes, polyamides (e.g., polyamide-6), polyesters, wood, paper, limonene, aldehydes, ketones, fatty acids, metals, and/or long term decomposition products of stabilizers.

“Cellulose-containing fibers” as used herein relate to fibers that contain cellulose, typically in combination with other components of natural plant fibers such as, but not limited to, hemicellulose, lignin, pectin, and the like. Thus, the term “cellulose-containing fibers” is meant to encompass plant fibers, like wood fibers, that contain cellulose fibers, e.g., in the form of lignocellulose fibers and/or other cellulose-containing plant fibers.

Where the term “comprising” is used in the present description and claims, it does not exclude other non-specified elements of major or minor functional importance. For the purposes of the present invention, the term “essentially consisting of” and “consisting of” are considered to be specific embodiments of the term “comprising of”. If hereinafter a group is defined to comprise at least a certain number of features or embodiments, this is also to be understood to disclose a group, which optionally essentially consists only of these features or embodiments or consists only of these features or embodiments. The term “essentially consisting of” is to be understood in that specific further components can be present, namely those not materially affecting the essential characteristics of the material to which the term refers.

Where the term “obtainable” is used, this shall always include the term “obtained” as a preferred embodiment. Whenever the terms “including” or “having” are used, these terms are meant to be equivalent to “comprising” as defined above. Unless clearly indicated otherwise, use of the terms “a”, “an,” and the like, refers to one or more. Amounts are given in % by weight (wt.-%) unless it is stated otherwise.

In the following, the present invention is described in more detail.

### DETAILED DESCRIPTION

### 1. The Composite Material

One aspect of the invention provides a composite material. The composite material is obtainable by blending the components (a) to (g), and optionally component (h):
(a) from 10.0 to 35.0 wt.-% of a first heterophasic propylene-ethylene copolymer (HECO1) having a melt flow rate (MFR₂), determined according to ISO 1133 at 230° C. and 2.16 kg, in the range from 60 to 200 g/10 min,
(b) from 5.0 to 25.0 wt.-% of a second heterophasic propylene-ethylene copolymer (HECO2) having
a melt flow rate (MFR₂), determined according to ISO 1133 at 230° C. and 2.16 kg, in the range from 4 to 30 g/10 min, and
a soluble fraction (SF), determined according to CRYSTEX QC analysis, in the range from 17.0 to 40.0 wt.-%, relative to the total weight of the second heterophasic propylene-ethylene copolymer (HECO2),
(c) from 8.0 to 40.0 wt.-% of a mixed-plastic polypropylene blend having a polypropylene content of at least 75 wt.-%, based on the total weight of the mixed-plastic polypropylene blend;
(d) from 8.0 to 18.0 wt.-% of an ethylene-based elastomer being a copolymer of ethylene and an alpha-olefin co-monomer having from 4 to 12 carbon atoms, and the ethylene-based elastomer having a density in the range of 850 to 900 kg/m³,
(e) from 5.0 to 30.0 wt.-% of cellulose-containing fibers,
(f) from 1.0 to 5.0 wt.-% of a compatibilizer being a polar modified polypropylene or a polar modified elastomer,
(g) from 0.1 to 5.0 wt.-% of additives,
(h) optionally from 0.1 to 15.0 wt.-% of a high density polyethylene, wherein the weight amounts of components (a) to (h) are defined relative to the total weight of the composite material.

In the following sections, the composite materials and its components are described in further detail.

### 1.1 Properties and Composition of the Composite Material

The composite material is obtainable by blending the components (a) to (g), and optionally component (h) as defined herein.

The blending of the components may be carried out by any blending, particularly melt-blending, that is suitable for preparing a composite material. The blending may be a melt-blending and/or melt-compounding of the components using a conventional compounding or blending apparatus, e.g., a Banbury mixer, a 2-roll rubber mill, Buss-co-kneader or a twin-screw extruder. Preferably, the blending is carried out in a plastic extruder, like a single screw extruder or a twin-screw extruder, and more preferably a twin screw extruder. The plastic extruder may be equipped with soft mixing elements. The melt-blending and/or melt-compounding may be carried out at a temperature in a range of 160 to 220° C., like in a range of 180 to 200° C. The composite material may be obtainable in the form of pellets.

The composite material is obtainable by blending the components (a) to (g), and optionally component (h):
(a) from 10.0 to 35.0 wt.-%, preferably from 11.0 to 32.0 wt.-%, more preferably from 12.0 to 30.0 wt.-%, and even more preferably from 13.0 to 29.0 wt.-%, of the first heterophasic propylene-ethylene copolymer (HECO1),
(b) from 5.0 to 25.0 wt.-%, preferably from 7.0 to 23.0 wt.-%, more preferably from 8.0 to 21.0 wt.-%, and even more preferably from 9.0 to 20.0 wt.-%, of the second heterophasic propylene-ethylene copolymer (HECO2),
(c) from 8.0 to 40.0 wt.-%, preferably from 10.0 to 37.0 wt.-%, more preferably 12.0 to 35.0 wt.-%, and even more preferably 13.0 to 33.0 wt.-%, of the mixed-plastic polypropylene blend;
(d) from 8.0 to 18.0 wt.-%, preferably from 9.0 to 17.0 wt.-%, more preferably from 10.0 to 16.0 wt.-%, and even more preferably from 10.0 to 14.0 wt.-%, of the ethylene-based elastomer,
(e) from 5.0 to 30.0 wt.-%, preferably from 8.0 to 28.0 wt.-%, more preferably from 10.0 to 26.0 wt.-%, and even more preferably from 12.0 to 22.0 wt.-%, of the cellulose-containing fibers,
(f) from 1.0 to 5.0 wt.-%, preferably from 1.0 to 5.0 wt.-%, more preferably from 1.5 to 4.5 wt.-%, and even more preferably from 2.0 to 4.0 wt.-%, of the compatibilizer,
(g) from 0.1 to 5.0 wt.-%, preferably from 0.5 to 5.0 wt.-%, more preferably from 1.0 to 5.0 wt.-%, and even more preferably from 2.0 to 5.0 wt.-%, of the additives, and
(h) optionally from 0.1 to 15.0 wt.-%, preferably from 1.0 to 15.0 wt.-%, more preferably from 2.0 to 12.0 wt.-%, and even more preferably from 5.0 to 11.0 wt.-%, of the high density polyethylene,
wherein the weight amounts of components (a) to (h) are defined relative to the total weight of the composite material.

The optional component (h) may be absent or may not be used to obtain the composite material. In said case, the weight amounts of components (a) to (g) may add up to at least 98.0 wt.-%, preferably at least 99.0 wt.-%, and more preferably to 100.0 wt.-%, relative to the total weight of the composite material.

Preferably, the composite material is obtainable using component (h). Thus, the composite material is preferably obtainable by blending the components (a) to (h):
(a) from 10.0 to 35.0 wt.-%, preferably from 11.0 to 32.0 wt.-%, more preferably from 12.0 to 30.0 wt.-%, and even more preferably from 13.0 to 29.0 wt.-%, of the first heterophasic propylene-ethylene copolymer (HECO1),
(b) from 5.0 to 25.0 wt.-%, preferably from 7.0 to 23.0 wt.-%, more preferably from 8.0 to 21.0 wt.-%, and even more preferably from 9.0 to 20.0 wt.-%, of the second heterophasic propylene-ethylene copolymer (HECO2),
(c) from 8.0 to 40.0 wt.-%, preferably from 10.0 to 37.0 wt.-%, more preferably 12.0 to 35.0 wt.-%, and even more preferably 13.0 to 33.0 wt.-%, of the mixed-plastic polypropylene blend;
(d) from 8.0 to 18.0 wt.-%, preferably from 9.0 to 17.0 wt.-%, more preferably from 10.0 to 16.0 wt.-%, and even more preferably from 10.0 to 14.0 wt.-%, of the ethylene-based elastomer,
(e) from 5.0 to 30.0 wt.-%, preferably from 8.0 to 28.0 wt.-%, more preferably from 10.0 to 26.0 wt.-%, and even more preferably from 12.0 to 22.0 wt.-%, of the cellulose-containing fibers,
(f) from 1.0 to 5.0 wt.-%, preferably from 1.0 to 5.0 wt.-%, more preferably from 1.5 to 4.5 wt.-%, and even more preferably from 2.0 to 4.0 wt.-%, of the compatibilizer,
(g) from 0.1 to 5.0 wt.-%, preferably from 0.5 to 5.0 wt.-%, more preferably from 1.0 to 5.0 wt.-%, and even more preferably from 2.0 to 5.0 wt.-%, of the additives, and
(h) from 0.1 to 15.0 wt.-%, preferably from 1.0 to 15.0 wt.-%, more preferably from 2.0 to 12.0 wt.-%, and even more preferably from 5.0 to 11.0 wt.-%, of the high density polyethylene,
wherein the weight amounts of components (a) to (h) are defined relative to the total weight of the composite material.

The weight amount of the components (a) to (h) may add up to at least 98.0 wt.-%, preferably at least 99.0 wt.-%, and more preferably to 100.0 wt.-%, relative to the total weight of the composite material. Thus, the composite material is preferably obtainable by blending the components (a) to (h):
(a) from 10.0 to 35.0 wt.-%, preferably from 11.0 to 32.0 wt.-%, more preferably from 12.0 to 30.0 wt.-%, and even more preferably from 13.0 to 29.0 wt.-%, of the first heterophasic propylene-ethylene copolymer (HECO1),
(b) from 5.0 to 25.0 wt.-%, preferably from 7.0 to 23.0 wt.-%, more preferably from 8.0 to 21.0 wt.-%, and even more preferably from 9.0 to 20.0 wt.-%, of the second heterophasic propylene-ethylene copolymer (HECO2),
(c) from 8.0 to 40.0 wt.-%, preferably from 10.0 to 37.0 wt.-%, more preferably 12.0 to 35.0 wt.-%, and even more preferably 13.0 to 33.0 wt.-%, of the mixed-plastic polypropylene blend;
(d) from 8.0 to 18.0 wt.-%, preferably from 9.0 to 17.0 wt.-%, more preferably from 10.0 to 16.0 wt.-%, and even more preferably from 10.0 to 14.0 wt.-%, of the ethylene-based elastomer,
(e) from 5.0 to 30.0 wt.-%, preferably from 8.0 to 28.0 wt.-%, more preferably from 10.0 to 26.0 wt.-%, and even more preferably from 12.0 to 22.0 wt.-%, of the cellulose-containing fibers,
(f) from 1.0 to 5.0 wt.-%, preferably from 1.0 to 5.0 wt.-%, more preferably from 1.5 to 4.5 wt.-%, and even more preferably from 2.0 to 4.0 wt.-%, of the compatibilizer,
(g) from 0.1 to 5.0 wt.-%, preferably from 0.5 to 5.0 wt.-%, more preferably from 1.0 to 5.0 wt.-%, and even more preferably from 2.0 to 5.0 wt.-%, of the additives, and
(h) from 0.1 to 15.0 wt.-%, preferably from 1.0 to 15.0 wt.-%, more preferably from 2.0 to 12.0 wt.-%, and even more preferably from 5.0 to 11.0 wt.-%, of the high density polyethylene,
wherein the weight amounts of components (a) to (h) are defined relative to the total weight of the composite material, and wherein the weight amounts add up to at least 98.0 wt.-%, preferably at least 99.0 wt.-%, and more preferably to 100.0 wt.-%.

In one embodiment, the composite material may comprise, may essentially consist of or may consist of components (a) to (h) as defined herein. In one embodiment, the composite material does not contain an inorganic filler and/or inorganic reinforcing agent (e.g., glass fibers and/or talc) in an amount of more than 5 wt.-%.

The composite material preferably comprises a mixed-plastic polypropylene blend originating from recycled material, preferably originating from post-industrial waste or post-consumer waste, and more preferably from post-consumer waste. The composite material may have a limonene content, determined by solid phase microextraction (HS-SPME-GC-MS), of at least 0.1 ppm, like in the range from 0.10 to 25.0 ppm. The presence of limonene is indicative that the composite material comprises a mixed-plastic polypropylene blend originating from recycled material, like post-consumer waste. Further indications that the composite material comprises a mixed plastic blend originating from recycled material (e.g., from post-consumer waste) may be that the composite material contains polystyrene, polyamide-6, and/or fatty acids.

The composite material typically has a melt flow rate that is suitable for application in injection molding processes. The composite material may have a melt flow rate (MFR₂), determined according to ISO 1133 at 230° C. and 2.16 kg, in the range from 8 to 80 g/10 min, preferably in the range of 9 to 75 g/10 min, more preferably in the range of 10 to 70 g/10 min, and even more preferably 10 to 60 g/10 min, like in the range of 10 to 30 g/10 min or 10 to 20 g/10 min.

The composite material may have a density of less than 1000 kg/m³, and preferably in the range of 900 to 990 kg/m³, like in the range of 920 to 990 kg/m³. When the composite material has a density of less than 1000 kg/m³, it is particularly useful for applications where a comparatively light weight is advantageous, like in the automotive sector.

The composite material typically has specific mechanical properties, like tensile properties and/or impact properties, which make it useful for application in manufacturing.

The composite material may have specific tensile properties. The composite material may have a tensile modulus, determined according to ISO 527-1A, of at least 1200 MPa, preferably at least 1300 MPa, more preferably at least 1400 MPa, and even more preferably at least 1450 MPa. The upper limit for the tensile modulus of the composite material may be 1900 MPa or 2000 MPa, determined according to ISO 527-1A. Thus, the composite material may have a tensile modulus, determined according to ISO 527-1A, in the range of 1200 to 2000 MPa, preferably 1300 to 2000 MPa, more preferably 1400 to 2000 MPa, and even more preferably 1450 to 2000 MPa, like in the range of 1500 to 1900 MPa.

The composite material may have a tensile strength, determined according to ISO 527-2, of at least 14 MPa, preferably at least 16 MPa, and more preferably at least 18 MPa. The composite material may have a tensile strength determined according to ISO 527-2 in the range of 14 to 30 MPa, preferably 16 to 28 MPa, and more preferably 18 to 26 MPa, like in the range of 20 to 24 MPa.

The composite material may have specific flexural properties. The composite material may have a flexural modulus, determined according to ISO 178, of at least 1100 MPa, preferably at least 1150 MPa, and more preferably at least 1200 MPa, like at least 1300 MPa. The composite material may have a flexural modulus, determined according to ISO 178, in the range of 1100 to 1900 MPa, preferably in the range of 1150 to 1850 MPa, and more preferably in the range of 1200 to 1850 MPa, like in the range of 1300 to 1800 MPa.

Further, the composite material may have a flexural strength, determined according to ISO 178, of at least 24 MPa, preferably at least 26 MPa, and more preferably at least 28 MPa, like in the range of 26 to 36 MPa or 28 to 34 MPa.

The composite material typically has high impact strength, like impact strength determined according to the Charpy tests for impact strength. The composite material may have a Charpy Notched impact strength at 23° C., determined according to ISO 179 1 eA, of at least 7.0 kJ/m², preferably at least 8.5 kJ/m², and more preferably at least 11.5 kJ/m², like at least 12.5 kJ/m². The composite material may have a Charpy Notched impact strength at 23° C., determined according to ISO 179 1 eA, in the range of 7.0 to 45.0 kJ/m², preferably in the range of 8.5 to 35.0 kJ/m², and more preferably 11.5 to 25.0 kJ/m², like in a range of 12.5 to 25.0 kJ/m².

Preferably, one or more of the above defined tensile and/or flexural properties and one or more of the above defined impact properties are realized in combination so that the composite material is characterized by a good balance between stiffness and impact.

According to one preferred embodiment, the composite material has:
a flexural modulus, determined according to ISO 178, of at least 1100 MPa, preferably at least 1150 MPa, and more preferably at least 1200 MPa; and
a Charpy Notched impact strength at 23° C., determined according to ISO 179 1 eA, of at least 7.0 kJ/m², preferably at least 8.5 kJ/m², and more preferably at least 11.0 kJ/m².

According to one preferred embodiment, the composite material has:
a flexural modulus, determined according to ISO 178, in the range of 1100 to 1900 MPa, preferably in the range of 1150 to 1850 MPa, and more preferably in the range of 1200 to 1850 MPa, like in the range of 1300 to 1800 MPa; and
a Charpy Notched impact strength at 23° C., determined according to ISO 179 1 eA, in the range of 7.0 to 45.0 kJ/m², preferably in the range of 8.5 to 35.0 kJ/m², and more preferably 11.5 to 25.0 kJ/m², like in a range of 12.5 to 20.0 kJ/m².

According to one preferred embodiment, the composite material has:
a flexural modulus, determined according to ISO 178, in the range of 1100 to 1900 MPa, preferably in the range of 1150 to 1850 MPa, and more preferably in the range of 1200 to 1850 MPa, like in the range of 1300 to 1800 MPa;
a tensile modulus, determined according to ISO 527-1A, in the range of 1200 to 2000 MPa, preferably 1300 to 2000 MPa, more preferably 1400 to 2000 MPa, and even more preferably 1450 to 2000 MPa, like in the range of 1500 to 1900 MPa,
a Charpy Notched impact strength at 23° C., determined according to ISO 179 1 eA, in the range of 7.0 to 45.0 kJ/m², preferably in the range of 8.5 to 35.0 kJ/m², and more preferably 11.5 to 25.0 kJ/m², like in a range of 12.5 to 20.0 kJ/m².

The polymeric part of the composite material may be characterized according to the CRYSTEX QC method, preferably using trichlorobenzene (TCB) as a solvent. This measuring method is further described below in section “Measuring methods”. CRYSTEX QC analysis is suitable to determine a crystalline fraction (CF) and a soluble fraction (SF) of the polymeric part of the composite material. The crystalline fraction (CF) contains for the most part the matrix phase and only a small part of the elastomeric phase and the soluble fraction (SF) contains for the most part the elastomeric phase and only a small part of the matrix phase. Due to the differences in the separation methods of cold xylene extraction and the CRYSTEX QC method, the properties of XCS/XCI fractions on the one hand and crystalline/soluble (CF/SF) fractions on the other hand are typically not exactly the same, meaning that the amounts of matrix phase and elastomeric phase can differ as well as the properties.

The polymeric part of the composite material may have an ethylene content (C2 (total)), determined by FT-IR spectroscopy calibrated by quantitative ¹³C-NMR spectroscopy, in the range from 16.0 to 34.0 wt.-%, preferably in the range from 20.0 to 32.0 wt.-%, and more preferably in the range from 25.0 to 30.0 wt.-%.

The polymeric part of the composite material may have a soluble fraction (SF) content, determined according to CRYSTEX QC analysis, in the range from 20.0 to 40.0 wt.-%, preferably in the range from 21.0 to 35.0 wt.-%, and more preferably in the range from 22.0 to 32.0 wt.-%, like in a range of 26.0 to 30.0 wt.-%.

Said soluble fraction (SF) may have an ethylene content (C2(SF)) determined by FT-IR spectroscopy calibrated by quantitative ¹³C-NMR spectroscopy, in the range from 45.0 to 65.0 wt.-%, preferably in the range from 47.0 to 63.0 wt.-%, and more preferably in the range from 50.0 to 62.0 wt.-%.

Said soluble fraction (SF) may have an intrinsic viscosity (iV(SF)), determined according to DIN ISO 1628/1, in the range from 1.80 to 3.40 dL/g, more preferably in the range from 1.90 to 3.10 dL/g, and even more preferably in the range from 2.00 to 2.80 dL/g, like in a range of 2.10 to 2.70 dL/g.

The polymeric part of the composite material has a crystalline fraction (CF) content that can be determined according to CRYSTEX QC analysis. The weight amount of the crystalline fraction (CF) and the soluble fraction (SF) adds up to 100 wt. % of the polymeric part of the composite material. Said crystalline fraction (CF) may have an ethylene content (C2(CF)) determined by FT-IR spectroscopy calibrated by quantitative ¹³C-NMR spectroscopy, in the range from 10.0 to 26.0 wt.-%, preferably in the range from 12.0 to 24.0 wt.-%, and more preferably from 14.0 to 22.0 wt.-%, like in the range from 16.0 to 20.0 wt.-%. Said crystalline fraction (CF) may have an intrinsic viscosity (iV(CF)), determined according to DIN ISO 1628/1, in the range from 0.90 to 2.10 dL/g, more preferably in the range from 1.10 to 2.00 dL/g, and even more preferably in the range from 1.20 to 1.90 dL/g.

In one embodiment, the polymeric part of the composite material has the following characteristics:
an ethylene content (C2(total)), determined by FT-IR spectroscopy calibrated by quantitative ¹³C-NMR spectroscopy, in the range from 16.0 to 34.0 wt.-%, preferably in the range from 20.0 to 32.0 wt.-%, and more preferably in the range from 25.0 to 30.0 wt.-%, and
a soluble fraction (SF) content, determined according to CRYSTEX QC analysis, in the range from 20.0 to 40.0 wt.-%, preferably in the range from 21.0 to 35.0 wt.-%, and more preferably in the range from 22.0 to 32.0 wt.-%, like in a range of 26.0 to 30.0 wt.-%,
   preferably said soluble fraction (SF) having an ethylene content (C2(SF)) determined by FT-IR spectroscopy calibrated by quantitative ¹³C-NMR spectroscopy, in the range from 45.0 to 65.0 wt.-%, more preferably in the range from 47.0 to 63.0 wt.-%, and even more preferably in the range from 50.0 to 62.0 wt.-%, and an intrinsic viscosity (iV(SF)), determined according to DIN ISO 1628/1, in the range from 1.80 to 3.40 dL/g, more preferably in the range from 1.90 to 3.10 dL/g, and even more preferably in the range from 2.00 to 2.80 dL/g, like in a range of 2.10 to 2.50 dL/g.

The composite material according to the invention is preferably useful for preparing injection molded articles. Preferably, the composite material is useful for preparing injection molded articles for manufacturing applications, like automotive manufacturing. Said injection molded articles are also further described herein below in section “Injection molded article”.

### 1.2 the First Heterophasic Propylene-Ethylene Copolymer (HECO1)

The composite material is obtainable from a first heterophasic propylene-ethylene copolymer (HECO1) as the component (a). The first heterophasic propylene-ethylene copolymer (HECO1) comprises:
i) a crystalline matrix phase; and
ii) an elastomeric phase being dispersed in said matrix phase.

The first heterophasic propylene-ethylene copolymer (HECO1) is provided in an amount from 10.0 to 35.0 wt.-%, preferably from 11.0 to 32.0 wt.-%, more preferably from 12.0 to 30.0 wt.-%, and even more preferably from 13.0 to 29.0 wt.-%, relative to the total weight of the composite material.

The first heterophasic propylene-ethylene copolymer (HECO1) has a melt flow rate (MFR₂), determined according to ISO 1133 at 230° C. and 2.16 kg, in the range from 60 to 200 g/10 min. Thus, the first heterophasic propylene-ethylene copolymer (HECO1) is characterized by a comparatively high melt flow rate. Preferably, the first heterophasic propylene-ethylene copolymer (HECO1) has a melt flow rate (MFR₂), determined according to ISO 1133 at 230° C. and 2.16 kg, in the range of 70 to 180 g/10 min, more preferably 75 to 160 g/10 min, and even more preferably in the range of 80 to 140 g/10 min, like in the range of 90 to 120 g/10 min.

The crystalline matrix phase of the first heterophasic propylene-ethylene copolymer (HECO1) may have a melt flow rate (MFR₂), determined according to ISO 1133 at 230° C. and 2.16 kg, in the range of 80 to 500 g/10 min, preferably 90 to 450 g/10 min, and more preferably in the range of 100 to 400 g/10 min, like in the range of 120 to 200 g/10 min.

The first heterophasic propylene-ethylene copolymer (HECO1) may have a melting temperature Tm, determined by differential scanning calorimetry (DSC), in the range of from 150 to 170° C., preferably 155 to 168° C., and more preferably 162 to 168° C.

The first heterophasic propylene-ethylene copolymer (HECO1) may be further defined by specific characteristics that are determined according to CRYSTEX QC analysis, preferably using trichlorobenzene as solvent.

The first heterophasic propylene-ethylene copolymer (HECO1) may have an ethylene content (C2(total)), determined by FT-IR spectroscopy calibrated by quantitative ¹³C-NMR spectroscopy, in the range from 2.0 to 14.0 wt.-%, preferably in the range from 2.5 to 12.5 wt.-%, and more preferably in the range from 3.0 to 11.5 wt.-%, like in the range from 5.0 to 11.0 wt.-%, relative to the total weight of the first heterophasic propylene-ethylene copolymer (HECO1).

The first heterophasic propylene-ethylene copolymer (HECO1) may have a soluble fraction (SF) content, determined according to CRYSTEX QC analysis, in the range from 6.0 to 22.0 wt.-%, preferably 8.0 to 20.0 wt.-%, and more preferably 10.0 to 19.0 wt.-%, relative to the total weight of the first heterophasic propylene-ethylene copolymer (HECO1).

The intrinsic viscosity, determined according to DIN ISO 1628/1, of the soluble fraction content (iV(SF)), according to CRYSTEX QC analysis, may be in the range from 1.5 to 3.5 dL/g, preferably 1.7 to 3.3 dL/g, and more preferably 1.8 to 3.2 dL/g.

The soluble fraction (SF) may have an ethylene content (C2(SF)), determined by FT-IR spectroscopy calibrated by quantitative ¹³C-NMR spectroscopy, in the range from 30.0 to 50.0 wt.-%, preferably in the range from 33.0 to 45.0 wt.-%, and more preferably in the range from 35.0 to 42.0 wt.-%, relative to the total weight of the soluble fraction (SF) of the first heterophasic propylene-ethylene copolymer (HECO1).

In one preferred embodiment, the first heterophasic propylene-ethylene copolymer (HECO1) has:
a soluble fraction (SF) content, determined according to CRYSTEX QC analysis, in the range from 6.0 to 22.0 wt.-%, preferably 8.0 to 20.0 wt.-%, and more preferably 10.0 to 19.0 wt.-%, relative to the total weight of the first heterophasic propylene-ethylene copolymer (HECO1), and
an intrinsic viscosity, determined according to DIN ISO 1628/1, of the soluble fraction content (iV(SF)), according to CRYSTEX QC analysis, in the range from 1.5 to 3.5 dL/g, preferably 1.7 to 3.3 dL/g, and more preferably 1.8 to 3.2 dL/g.

In one more preferred embodiment, the first heterophasic propylene-ethylene copolymer (HECO1) has:
a soluble fraction (SF) content, determined according to CRYSTEX QC analysis, in the range from 6.0 to 22.0 wt.-%, preferably 8.0 to 20.0 wt.-%, and more preferably 10.0 to 19.0 wt.-%, relative to the total weight of the first heterophasic propylene-ethylene copolymer (HECO1),
an intrinsic viscosity, determined according to DIN ISO 1628/1, of the soluble fraction content (iV(SF)), according to CRYSTEX QC analysis, in the range from 1.5 to 3.5 dL/g, preferably 1.7 to 3.3 dL/g, and more preferably 1.8 to 3.2 dL/g, and
the soluble fraction (SF) has an ethylene content (C2(SF)), determined by FT-IR spectroscopy calibrated by quantitative ¹³C-NMR spectroscopy, in the range from 30.0 to 50.0 wt.-%, preferably in the range from 33.0 to 45.0 wt.-%, and more preferably in the range from 35.0 to 42.0 wt.-%, relative to the total weight of the soluble fraction (SF) of the first heterophasic propylene-ethylene copolymer (HECO1).

The first heterophasic propylene-ethylene copolymer (HECO1) may have a crystalline fraction (CF) content, determined according to CRYSTEX QC analysis, in the range from 78.0 to 94.0 wt.-%, preferably 80.0 to 92.0 wt.-%, and more preferably 81.0 to 90.0 wt.-%, relative to the total weight of the first heterophasic propylene-ethylene copolymer (HECO1).

The crystalline fraction (CF) may have an ethylene content (C2(CF)), determined by FT-IR spectroscopy calibrated by quantitative ¹³C-NMR spectroscopy, of less than 5.0 wt.-%, preferably in the range from 0.1 to 4.0 wt.-%, and more preferably in the range from 0.5 to 3.5 wt.-%, like in the range of 1.5 to 3.5 wt.-%, relative to the total weight of the crystalline fraction (CF) of the first heterophasic propylene-ethylene copolymer (HECO1).

The intrinsic viscosity, determined according to DIN ISO 1628/1, of the crystalline fraction content (iV(CF)), according to CRYSTEX QC analysis, may be in the range from 0.7 to 2.0 dL/g, preferably 0.8 to 1.8 dL/g, and more preferably 0.9 to 1.6 dL/g.

In one preferred embodiment, the first heterophasic propylene-ethylene copolymer (HECO1) has:
a crystalline fraction (CF) content, determined according to CRYSTEX QC analysis, in the range from 78.0 to 94.0 wt.-%, preferably 80.0 to 92.0 wt.-%, and more preferably 81.0 to 90.0 wt.-%, relative to the total weight of the first heterophasic propylene-ethylene copolymer (HECO1),
the crystalline fraction (CF) having an ethylene content (C2(CF)), determined by FT-IR spectroscopy calibrated by quantitative ¹³C-NMR spectroscopy, of less than 5.0 wt.-%, preferably in the range from 0.1 to 4.0 wt.-%, and more preferably in the range from 0.5 to 3.5 wt.-%, relative to the total weight of the crystalline fraction (CF) of the first heterophasic propylene-ethylene copolymer (HECO1), and
an intrinsic viscosity, determined according to DIN ISO 1628/1, of the crystalline fraction content (iV(CF)), according to CRYSTEX QC analysis, in the range from 0.7 to 2.0 dL/g, preferably 0.8 to 1.8 dL/g, and more preferably 0.9 to 1.6 dL/g.

The first heterophasic propylene-ethylene copolymer (HECO1) may be characterized by a ratio of the intrinsic viscosity of the soluble fraction content (iV(SF)), according to CRYSTEX QC analysis, to the intrinsic viscosity of the crystalline fraction (iV(CF)), according to CRYSTEX QC analysis, of more than 1.0, preferably in the range of from 1.2 to 3.5, and more preferably in the range of 1.5 to 3.0, the intrinsic viscosity being determined according to DIN ISO 1628/1.

Additionally or alternatively, the first heterophasic propylene-ethylene copolymer (HECO1) may be characterized by its xylene cold solubles (XCS) fraction.

The first heterophasic polypropylene copolymer (HECO1) may have one or more of, preferably all of:
a xylene cold soluble (XCS) content, determined at 25° C. according ISO 16152, in the range of 6.5 to 23.0 wt.-%, preferably 8.5 to 21.0 wt.-%, and more preferably 10.5 to 20.0 wt.-%, based on the overall weight of the first heterophasic polypropylene copolymer (HECO1), and
an intrinsic viscosity (IV) determined according to DIN ISO 1628/1 in decalin at 135° C. of the XCS fraction in the range of from 1.4 to 3.4 dl/g, preferably 1.6 to 3.2 dl/g, and more preferably 1.7 to 3.1 dl/g.

The first heterophasic polypropylene copolymer (HECO1) may be obtainable by a Ziegler-Natta-catalyst based polymerization process. The process is typically carried out in a sequential polymerization reactor, like a loop reactor connected to two or more gas phase reactors. An example for such a process is described in detail herein below in the section “Experimental section”.

The first heterophasic polypropylene copolymer (HECO1) is a material that, as such, is known in the art and commercially available.

### 1.3 the Second Heterophasic Propylene-Ethylene Copolymer (HECO2)

The composite material is obtainable from a second heterophasic propylene-ethylene copolymer (HECO2) as the component (b). The second heterophasic propylene-ethylene copolymer (HECO2) comprises:
i) a crystalline matrix phase; and
ii) an elastomeric phase being dispersed in said matrix phase.

The second heterophasic propylene-ethylene copolymer (HECO2) is provided in an amount in the range of from 5.0 to 25.0 wt.-%, preferably from 7.0 to 23.0 wt.-%, more preferably from 8.0 to 21.0 wt.-%, and even more preferably from 9.0 to 20.0 wt.-%, relative to the total weight of the composite material.

The second heterophasic propylene-ethylene copolymer (HECO2) has a melt flow rate (MFR₂), determined according to ISO 1133 at 230° C. and 2.16 kg, in the range from 4 to 30 g/10 min. Thus, the second heterophasic propylene-ethylene copolymer (HECO2) is characterized by a lower melt flow rate than the first heterophasic propylene-ethylene copolymer (HECO1). Preferably, the second heterophasic propylene-ethylene copolymer (HECO2) has a melt flow rate (MFR₂), determined according to ISO 1133 at 230° C. and 2.16 kg, in the range from 4 to 25 g/10 min, preferably from 4 to 20 g/10 min, and more preferably from 5 to 15 g/10 min, like in the range of 5 to 10 g/10 min.

The second heterophasic propylene-ethylene copolymer (HECO2) may have a melting temperature Tm, determined by differential scanning calorimetry (DSC), in the range of from 150 to 170° C., preferably 155 to 168° C., and more preferably 162 to 168° C.

The second heterophasic propylene-ethylene copolymer (HECO2) may be further defined by specific characteristics that are determined according to CRYSTEX QC analysis, preferably using trichlorobenzene as solvent.

The second heterophasic propylene-ethylene copolymer (HECO2) may have an ethylene content (C2(total)), determined by FT-IR spectroscopy calibrated by quantitative ¹³C-NMR spectroscopy, in the range from 4.5 to 25.0 wt.-%, preferably in the range from 5.5 to 22.0 wt.-%, and more preferably in the range from 6.0 to 20.0 wt.-%, relative to the total weight of the second heterophasic propylene-ethylene copolymer (HECO2).

The second heterophasic propylene-ethylene copolymer (HECO2) has a soluble fraction (SF) content, determined according to CRYSTEX QC analysis, in the range from 17.0 to 40.0 wt.-%, relative to the total weight of the second heterophasic propylene-ethylene copolymer (HECO2). Preferably, the second heterophasic propylene-ethylene copolymer (HECO2) has a soluble fraction (SF) content, determined according to CRYSTEX QC analysis, in the range from 18.0 to 38.0 wt.-%, preferably 19.0 to 35.0 wt.-%, and more preferably 19.0 to 33.0 wt.-%, relative to the total weight of the second heterophasic propylene-ethylene copolymer (HECO2).

The intrinsic viscosity, determined according to DIN ISO 1628/1, of the soluble fraction content (iV(SF)), according to CRYSTEX QC analysis, may be in the range from 2.0 to 7.0 dL/g, preferably from 2.5 to 6.8 dL/g, and more preferably from 3.5 to 6.5 dL/g.

The soluble fraction (SF) may have an ethylene content (C2(SF)), determined by FT-IR spectroscopy calibrated by quantitative ¹³C-NMR spectroscopy, in the range from 20.0 to 50.0 wt.-%, preferably in the range from 20.0 to 45.0 wt.-%, and more preferably in the range from 21.0 to 40.0 wt.-%, relative to the total weight of the soluble fraction (SF) of the second heterophasic propylene-ethylene copolymer (HECO2).

In one preferred embodiment, the second heterophasic propylene-ethylene copolymer (HECO2) has:
a soluble fraction (SF) content, determined according to CRYSTEX QC analysis, in the range from 18.0 to 38.0 wt.-%, preferably 19.0 to 35.0 wt.-%, and more preferably 19.0 to 33.0 wt.-%, relative to the total weight of the second heterophasic propylene-ethylene copolymer (HECO2), and
an intrinsic viscosity, determined according to DIN ISO 1628/1, of the soluble fraction content (iV(SF)), according to CRYSTEX QC analysis, in the range from 2.0 to 7.0 dL/g, preferably from 2.5 to 6.8 dL/g, and more preferably from 3.5 to 6.5 dL/g.

In one more preferred embodiment, the second heterophasic propylene-ethylene copolymer (HECO2) has:
a soluble fraction (SF) content, determined according to CRYSTEX QC analysis, in the range from 18.0 to 38.0 wt.-%, preferably 19.0 to 35.0 wt.-%, and more preferably 19.0 to 33.0 wt.-%, relative to the total weight of the second heterophasic propylene-ethylene copolymer (HECO2),
an intrinsic viscosity, determined according to DIN ISO 1628/1, of the soluble fraction content (iV(SF)), according to CRYSTEX QC analysis, in the range from 2.0 to 7.0 dL/g, preferably from 2.5 to 6.8 dL/g, and more preferably from 3.5 to 6.5 dL/g, and
the soluble fraction (SF) has an ethylene content (C2(SF)), determined by FT-IR spectroscopy calibrated by quantitative ¹³C-NMR spectroscopy, in the range from 20.0 to 50.0 wt.-%, preferably in the range from 20.0 to 45.0 wt.-%, and more preferably in the range from 21.0 to 40.0 wt.-%, relative to the total weight of the soluble fraction (SF) of the second heterophasic propylene-ethylene copolymer (HECO2).

The second heterophasic propylene-ethylene copolymer (HECO2) has a crystalline fraction (CF) content, determined according to CRYSTEX QC analysis, in the range from 60.0 to 83.0 wt.-%, preferably 62.0 to 82.0 wt.-%, and more preferably 65.0 to 81.0 wt.-%, relative to the total weight of the second heterophasic propylene-ethylene copolymer (HECO2).

The crystalline fraction (CF) may have an ethylene content (C2(CF)), determined by FT-IR spectroscopy calibrated by quantitative ¹³C-NMR spectroscopy, in the range from 1.0 to 10.0 wt.-%, preferably in the range from 1.5 to 9.0 wt.-%, and more preferably in the range from 2.0 to 6.0 wt.-%, relative to the total weight of the crystalline fraction (CF) of the second heterophasic propylene-ethylene copolymer (HECO2).

The intrinsic viscosity, determined according to DIN ISO 1628/1, of the crystalline fraction content (iV(CF)), according to CRYSTEX QC analysis, may be in the range from 1.0 to 3.5 dL/g, preferably 1.1 to 3.0 dL/g, and more preferably 1.2 to 2.5 dL/g.

In one preferred embodiment, the second heterophasic propylene-ethylene copolymer (HECO2) has:
a crystalline fraction (CF) content, determined according to CRYSTEX QC analysis in the range from 60.0 to 83.0 wt.-%, preferably 62.0 to 82.0 wt.-%, and more preferably 65.0 to 81.0 wt.-%, like in the range of 74.0 to 81.0 wt.-%, relative to the total weight of the second heterophasic propylene-ethylene copolymer (HECO2),
the crystalline fraction (CF) having an ethylene content (C2(CF)), determined by FT-IR spectroscopy calibrated by quantitative ¹³C-NMR spectroscopy, in the range from 1.0 to 10.0 wt.-%, preferably in the range from 1.5 to 9.0 wt.-%, and more preferably in the range from 2.0 to 6.0 wt.-%, relative to the total weight of the crystalline fraction (CF) of the second heterophasic propylene-ethylene copolymer (HECO2), and
an intrinsic viscosity, determined according to DIN ISO 1628/1, of the crystalline fraction content (iV(CF)), according to CRYSTEX QC analysis, 1.0 to 3.5 dL/g, preferably 1.1 to 3.0 dL/g, and more preferably 1.2 to 2.5 dL/g.

The second heterophasic propylene-ethylene copolymer (HECO2) may be characterized by a ratio of the intrinsic viscosity of the soluble fraction content (iV(SF)), according to CRYSTEX QC analysis, to the intrinsic viscosity of the crystalline fraction (iV(CF)), according to CRYSTEX QC analysis, in the range of from 1.2 to 6.0, preferably from 1.5 to 5.0, and more preferably in the range of from 2.0 to 4.0, the intrinsic viscosity being determined according to DIN ISO 1628/1.

In one preferred embodiment, the second heterophasic propylene-ethylene copolymer (HECO2) has:
a soluble fraction (SF) content, determined according to CRYSTEX QC analysis, in the range from 18.0 to 38.0 wt.-%, preferably 19.0 to 35.0 wt.-%, and more preferably 19.0 to 33.0 wt.-%, relative to the total weight of the second heterophasic propylene-ethylene copolymer (HECO2),
a ratio of the intrinsic viscosity of the soluble fraction content (iV(SF)), according to CRYSTEX QC analysis, to the intrinsic viscosity of the crystalline fraction (iV(CF)), according to CRYSTEX QC analysis, in the range of from 1.2 to 6.0, preferably from 1.5 to 5.0, and more preferably in the range of from 2.0 to 4.0, the intrinsic viscosity being determined according to DIN ISO 1628/1, and
the soluble fraction (SF) has an ethylene content (C2(SF)), determined by FT-IR spectroscopy calibrated by quantitative ¹³C-NMR spectroscopy, in the range from 20.0 to 50.0 wt.-%, preferably in the range from 20.0 to 45.0 wt.-%, and more preferably in the range from 21.0 to 40.0 wt.-%, relative to the total weight of the soluble fraction (SF) of the second heterophasic propylene-ethylene copolymer (HECO2).

Additionally or alternatively, the second heterophasic propylene-ethylene copolymer (HECO2) may be characterized by its xylene cold solubles (XCS) fraction.

The second heterophasic polypropylene copolymer (HECO2) may have one or more of, preferably all of:
a xylene cold soluble (XCS) content, determined at 25° C. according ISO 16152, in the range of 18.0 to 42.0 wt.-%, preferably 19.0 to 40.0 wt.-%, and more preferably 20.0 to 36.5 wt.-%, based on the overall weight of the second heterophasic polypropylene copolymer (HECO2), and
an intrinsic viscosity (IV) determined according to DIN ISO 1628/1 in decalin at 135° C. of the XCS fraction in the range of from 2.0 to 7.0 dl/g, preferably 2.1 to 6.8 dl/g, and more preferably 3.5 to 6.5 dl/g.

The second heterophasic polypropylene copolymer (HECO2) is typically obtainable by a Ziegler-Natta-catalyst based polymerization process. The process is typically carried out in a sequential polymerization reactor, like a loop reactor connected to two or more gas phase reactors. An example for such a process is described in detail herein below in the section “Experimental section”.

The second heterophasic polypropylene copolymer (HECO2) is a material that is known in the art as such and that is commercially available.

### 1.4 the Mixed-Plastic Polypropylene Blend

The composite material is obtainable from a mixed-plastic polypropylene blend as the component (c). The mixed-plastic polypropylene blend is provided in an amount in the range from 8.0 to 40.0 wt.-%, preferably from 10.0 to 37.0 wt.-%, more preferably 12.0 to 35.0 wt.-%, and even more preferably 13.0 to 33.0 wt.-%, relative to the total weight of the composite material.

The mixed-plastic polypropylene blend has a polypropylene content of at least 75 wt.-%, based on the total weight of the mixed-plastic polypropylene blend. Thus, the mixed-plastic polypropylene blend is a propylene rich plastic blend. Preferably, the mixed-plastic polypropylene blend has a polypropylene content in the range of from 80 to 99 wt.-%, preferably from 83 to 96 wt.-%, based on the total weight of the mixed-plastic polypropylene blend. The mixed-plastic polypropylene blend comprises one or more additional plastics. The one or more additional plastics typically comprise at least a polyethylene.

Preferably, the mixed-plastic polypropylene blend is a recycled material. The recycled material may be obtained from recycled waste by means of plastic recycling processes known in the art.

The recycled waste may be derived from different waste streams or may be a combination of different recyclates. Recycled waste or recyclates are commercially available, e.g. from Corepla (Italian Consortium for the collection, recovery, recycling of packaging plastic wastes), Resource Plastics Corp. (Brampton, ON), Kruschitz GmbH, Plastics and Recycling (AT), Vogt Plastik GmbH (DE), Mtm Plastics GmbH (DE), Morssinkhof-Rymoplast (NL) etc. Non-exhaustive examples of polypropylene rich recycled materials include: Purpolen® PP (Mtm Plastics GmbH), Axpoly® recycled polypropylene pellets (Axion Ltd), Moprylene (Morssinkhof-Rymoplast) and PolyPropylene Copolymer (BSP Compounds). During recycling, any reasonable measure will usually be taken for any components other than polyethylene and polypropylene to be reduced/removed as far as the final application or use suggests such measures; however, other components are often present in small amounts. Other such components include polystyrene (PS), polyamides (PA), polyethylene terephthalate (PET), which are all present in as low an amount as possible, often below the detection limit. Recycled waste and recyclates may differ in terms of plastic components depending on the source of recycled material. A skilled person is aware of said difference and can analyze the differences of recycled waste streams (typically such pieces of information are also available on the market). If necessary, a skilled person can combine different recycled waste streams to achieve a target composition of a mixed plastic blend.

The mixed-plastic polypropylene blend preferably is a recycled material originating from post-industrial waste or post-consumer waste, and more preferably from post-consumer waste.

The mixed-plastic polypropylene blend preferably has a limonene content, determined by solid phase microextraction (HS-SPME-GC-MS), of at least 0.1 ppm, more preferably in the range from 0.10 to 25.0 ppm. The presence of limonene is indicative that the mixed-plastic polypropylene blend originates from recycled material, like post-consumer waste. Further indications that the mixed plastic blend originates from recycled material (e.g., from post-consumer waste) may be that the mixed-plastic polypropylene blend contains polystyrene, polyamide-6, and/or fatty acids.

The mixed-plastic polypropylene blend may have an inorganic residue content, as determined by calcination analysis according to DIN ISO 1172:1996, of 0.05 to 3.0 wt.-%, like in the range from 0.50 to 2.5 wt.-%.

The mixed-plastic polypropylene blend preferably has a melt flow (MFR₂), determined according to ISO 1133 at 230° C. and 2.16 kg, in the range from 2 to 70 g/10 min, preferably from 5 to 40 g/10 min, and more preferably from 8 to 35 g/10 min, like in the range of 10 to 30 g/10 min.

The mixed-plastic polypropylene blend preferably has a soluble fraction (SF) content, determined according to CRYSTEX QC analysis, in the range from 4.0 to 16.0 wt.-%, preferably 6.0 to 14.0 wt.-%, and more preferably 8.0 to 12.0 wt.-%, relative to the total weight of the mixed-plastic polypropylene blend.

Said soluble fraction (SF) may have an ethylene content (C2(SF)), determined by FT-IR spectroscopy calibrated by quantitative ¹³C-NMR spectroscopy, in the range from 20.0 to 55.0 wt.-%, more preferably in the range from 22.0 to 50.0 wt.-%, most preferably in the range from 24.0 to 48.0 wt.-%, like in a range of 24.0 to 35.0 wt.-%. The intrinsic viscosity (iV(SF)) of said soluble fraction, determined according to DIN ISO 1628/1, may be in the range from 0.90 to 2.2 dL/g, preferably from 1.1 to 2.1 dL/g, and more preferably from 1.3 to 2.0 dL/g.

Additionally or alternatively, the mixed-plastic polypropylene blend preferably has a crystalline fraction (CF) content, determined according to CRYSTEX QC analysis, in the range from 84.0 to 96.0 wt.-%, preferably 86.0 to 94.0 wt-. %, and more preferably 88.0 to 92.0 wt.-%, relative to the total weight of the mixed-plastic polypropylene blend. Said crystalline fraction (CF) preferably has an ethylene content (C2(CF)), determined by FT-IR spectroscopy calibrated by quantitative ¹³C-NMR spectroscopy, in the range from 1.0 to 12.0 wt.-%, preferably in the range from 1.5 to 10.0 wt.-%, and more preferably in the range from 2.0 to 9.0 wt.-%, like in a range of 2.0 to 5.0 wt.-%, relative to the total weight of the crystalline fraction (CF) of the mixed-plastic polypropylene blend. The intrinsic viscosity (iV(SF)) of said crystalline fraction, determined according to DIN ISO 1628/1, may be in the range from 0.80 to 2.1 dL/g, preferably from 1.0 to 2.0 dL/g, and more preferably from 1.1 to 1.9 dL/g.

In one embodiment, the mixed-plastic polypropylene blend having at least one, preferably at least two, more preferably at least three, and even more preferably all, of the following characteristics:
a melt flow rate (MFR₂), determined according to ISO 1133 at 230° C. and 2.16 kg, in the range from 2 to 70 g/10 min, preferably from 5 to 40 g/10 min, and more preferably from 8 to 35 g/10 min;
a soluble fraction (SF) content in the range from 4.0 to 16.0 wt.-%, preferably 6.0 to 14.0 wt.-%, and more preferably 8.0 to 12.0 wt.-%, relative to the total weight of the mixed-plastic polypropylene blend, and a crystalline fraction (CF) content in the range from 84.0 to 96.0 wt.-%, preferably 86.0 to 94.0 wt.-%, and more preferably 88.0 to 92.0 wt.-%, relative to the total weight of the mixed-plastic polypropylene blend, both fractions determined according to CRYSTEX QC analysis;
a crystalline fraction (CF) having an ethylene content (C2(CF)), determined by FT-IR spectroscopy calibrated by quantitative ¹³C-NMR spectroscopy, in the range from 1.0 to 12.0 wt.-%, preferably in the range from 1.5 to 10.0 wt.-%, and more preferably in the range from 2.0 to 9.0 wt.-%, relative to the total weight of the crystalline fraction (CF) of the mixed-plastic polypropylene blend;
an intrinsic viscosity of the soluble fraction (iV(SF)), according to CRYSTEX QC analysis, determined according to DIN ISO 1628/1, in the range from 0.90 to 2.2 dL/g, preferably from 1.1 to 2.1 dL/g, and more preferably from 1.3 to 2.0 dL/g; and
having a polypropylene content in the range of from 80 to 99 wt.-%, preferably from 83 to 96 wt.-%, based on the total weight of the mixed-plastic polypropylene blend.

### 1.5 the Ethylene-Based Elastomer

The composite material is obtainable from an ethylene-based elastomer as the component (d). The ethylene-based elastomer is provided in an amount of from 8.0 to 18.0 wt.-%, preferably from 9.0 to 17.0 wt.-%, more preferably from 10.0 to 16.0 wt.-%, and even more preferably from 10.0 to 14.0 wt.-%, relative to the total weight of the composite material.

The ethylene-based elastomer is a copolymer of ethylene and an alpha-olefin co-monomer having from 4 to 12 carbon atoms. Preferably, the ethylene-based elastomer is a copolymer of ethylene and an alpha-olefin co-monomer having from 4 to 8 carbon atoms. More preferably, the ethylene-based elastomer is a copolymer of ethylene and 1-octene.

In one preferred embodiment, the ethylene-based elastomer is a copolymer of ethylene and 1-octene having a content of units derived from 1-octene in the range of 15 to 55 wt.-%, and preferably in the range of 20 to 50 wt.-%, based on the overall weight of the ethylene-based elastomer.

Furthermore, the ethylene-based elastomer has a density in the range from 850 to 900 kg/m³, preferably in the range of from 855 to 895 kg/m³, more preferably in the range of from 856 to 890 kg/m³, like in a range of 856 to 880 kg/m³.

The ethylene-based elastomer may have a melt a melt flow rate (MFR₂), determined according to ISO 1133 at 190° C. and 2.16 kg, in the range from 0.5 to 30 g/10 min, and preferably in a range of 0.8 to 25 g/10 min, like in a range of 0.8 to 15 g/10 min, 0.8 to 10 g/10 min or 0.8 to 5 g/10 min.

Ethylene-based elastomers as described herein are known in the art as such and are commercially available. For example, one suitable ethylene-based elastomer is the ethylene-octene copolymer available under the tradename “Engage 8842” from the Dow Chemical Company.

A skilled person is also aware how the ethylene-based elastomers described herein may be prepared. Preparation processes may be, but are not limited to, polymerizing ethylene and 1-octene in the presence of a metallocene catalyst in a gas phase reactor.

### 1.6 the Cellulose-Containing Fibers

The composite material is obtainable using cellulose-containing fibers as the component (e). The cellulose-containing fibers are provided in an amount from 5.0 to 30.0 wt.-%, preferably from 8.0 to 28.0 wt.-%, more preferably from 10.0 to 26.0 wt.-%, and even more preferably from 12.0 to 22.0 wt.-%, relative to the total weight of the composite material.

The cellulose-containing fibers may be obtained from any type of plant that contains natural cellulose-containing fibers such as, but not limited to, wood, bamboo, hemp, flax, kenaf, and the like. Preferably, the cellulose-containing fibers are wood fibers. The wood may be, but is not limited to, softwood (e.g., fir, cedar, pine, spruce, and many more) and hardwood (e.g., birch, ash, oak, walnut, and many more). More preferably, the cellulose-containing fibers are softwood fibers. Thus, the cellulose-containing fibers may be obtained from wood, and preferably softwood.

Preferably, the cellulose-containing fibers are plant fibers obtained from a plant by a mechanical and/or thermo-mechanical process. “Mechanical and/or thermo-mechanical process” does not contain chemical treatment steps for removing specific components from the fibers, like those chemical treatment steps used for preparing cellulose fiber for paper making. In one preferred embodiment, the cellulose-containing fibers are wood fibers obtained from wood, and preferably from softwood, by a mechanical and/or thermo-mechanical process.

The cellulose-containing fibers may contain from 30 to 95 wt.-% of cellulose, like in the range of 40 to 85 wt.-% or 50 to 85 wt.-%. Other components are typically hemicellulose and/or lignin. The cellulose-containing fibers may be lignocellulose fibers. In one preferred embodiment, the cellulose-containing fibers are lignocellulose fibers obtained from wood, and more preferably from softwood.

The cellulose-containing fibers may have a length in the range of 0.10 to 2.0 mm, optionally in the range of 0.15 to 1.5 mm. The cellulose-containing fibers may have an average fiber length, preferably a weight-based average fiber length, in the range of 0.10 to 2.0 mm, preferably in the range of 0.15 to 1.50 mm, and more preferably in the range of 0.30 to 1.2 mm. The cellulose-containing fibers may have an average aspect ratio, and preferably a weight-based average aspect ratio, of at least 1.5, preferably at least 1.8, and more preferably at least 2.2. An upper limit for the average aspect ration, preferably the weight-based average aspect ratio, may be 3.0 or 3.2. According to one preferred embodiment, the cellulose-containing fibers have a weight-based average fiber length in the range of 0.10 to 2.0 mm, preferably in the range of 0.15 to 1.50 mm, and more preferably in the range of 0.30 to 1.2 mm, and a weight-based average aspect ratio of at least 1.5, preferably at least 1.8, and more preferably at least 2.2. According to one preferred embodiment, the cellulose-containing fibers are wood fibers, more preferably softwood fibers, having a weight-based average fiber length in the range of 0.10 to 2.0 mm, preferably in the range of 0.15 to 1.50 mm, and more preferably in the range of 0.30 to 1.2 mm.

The average fiber length, like the weight-based average fiber length, and the average aspect ratio, like the weight-based average aspect ratio, are preferably determined according to FASEP analysis. FASEP analysis is also described herein below in the section “Measuring methods”.

Cellulose-containing fibers as described herein above are commercially available. For example, wood fibers are available under the tradename “Arbocel” by the company “Rettenmaier & Söhne”.

### 1.7 the Compatibilizer

The composite material is obtainable from a compatibilizer as the component (f). The compatibilizer is provided in an amount from 1.0 to 5.0 wt.-%, preferably from 1.0 to 5.0 wt.-%, more preferably from 1.5 to 4.5 wt.-%, and even more preferably from 2.0 to 4.0 wt.-%, relative to the total weight of the composite material.

The compatibilizer is a polar modified polypropylene or a polar modified elastomer, like a polar modified ethylene elastomer. Preferably, the compatibilizer is a polar modified polypropylene. The polar modified polypropylene may be a polar modified propylene homo- or copolymer.

The polar modified propylene homo- or copolymer may be a polar propylene homo- or copolymer comprising polar groups selected from the group consisting of acid anhydrides, carboxylic acids, carboxylic acid derivatives, primary and secondary amines, hydroxyl compounds, oxazoline and epoxides, ionic compounds, and combinations thereof.

The polar modified propylene homo- or copolymer may be a propylene homo- or copolymer grafted with polar compounds. Specific examples of said polar compounds are unsaturated cyclic anhydrides and their aliphatic diesters, and the diacid derivatives, such as, but not limited to, maleic anhydride and compounds selected from C1 to C10 linear and branched dialkyl maleates, C1 to C10 linear and branched dialkyl fumarates, itaconic anhydride, C1 to C10 linear and branched itaconic acid dialkyl esters, acrylic acid, maleic acid, fumaric acid, itaconic acid and mixtures thereof.

The polar modified propylene homo- or copolymer may comprise polar groups in an amount from 0.5 to 5.0 wt.-%, based on the total weight of the polar modified propylene homo- or copolymer. For example, the amount may be in the range of 0.5 wt.-% to 4.5 wt.-%, preferably in the range of 0.5 wt.-% to 4.0 wt.-%, more preferably in the range of 0.5 wt.-% to 3.5 wt.-%.

Preferably, the compatibilizer is a polar modified propylene homo- or copolymer, wherein the polar modified propylene homo- or copolymer is a propylene homo- or copolymer grafted with maleic anhydride and/or acrylic acid, and more preferably maleic anhydride.

A propylene homo- or copolymer grafted with a polar compound (e.g., maleic anhydride and/or acrylic acid) may be produced in a simple manner by reactive extrusion of the polymer with the polar graft compound in the presence of free radical generators (like organic peroxides), as disclosed for instance in U.S. Pat. Nos. 4,506,056, 4,753,997 or EP 1 805 238.

The melt flow rate MFR₂ (230° C., 2.16 kg) of the compatibilizer, preferably the polar modified propylene homo- or copolymer, may be at least 20 g/10 min, and preferably in the range of from 25.0 to 250 g/10 min, like in a range of 40.0 to 100 g/10 min. According to one preferred embodiment, the compatibilizer is a polar modified propylene homo- or copolymer, which is a propylene homo- or copolymer being grafted with maleic anhydride and having a melt flow rate MFR₂ (230° C., 2.16 kg) determined according to ISO 1133 in the range of 20.0 g/10 min to 250 g/10 min.

Compatibilizers as described herein are known in the art as such and are commercially available on the market.

### 1.8 the High Density Polyethylene

The composite material is obtainable from a high density polyethylene as the optional component (h). Preferably, the composite material is obtainable by using a high density polyethylene as the component (h).

The high density polyethylene may be provided in an amount from 0.1 to 15.0 wt.-%, preferably from 1.0 to 15.0 wt.-%, more preferably from 2.0 to 12.0 wt.-%, and even more preferably from 5.0 to 11.0 wt.-%, relative to the total weight of the composite material.

The high density polyethylene preferably has a density in the range of 945 to 965 kg/m³, and more preferably in the range of from 948 to 962 kg/m³.

The high density polyethylene may have a melt flow rate (MFR₂), determined according to ISO 1133 at 190° C. and 2.16 kg, in the range from 0.5 to 30 g/10 min, preferably from 1.0 to 30 g/10 min, and more preferably from 2.0 to 20 g/10 min, like in the range of 2.0 to 10 g/10 min.

According to one preferred embodiment, the high density polyethylene preferably has a density in the range of 945 to 965 kg/m³, and more preferably in the range of from 948 to 962 kg/m³, and a melt flow rate (MFR₂), determined according to ISO 1133 at 190° C. and 2.16 kg, in the range from 0.5 to 30 g/10 min, preferably from 1.0 to 30 g/10 min, and more preferably from 2.0 to 20 g/10 min, like in the range of 2.0 to 10 g/10 min.

High density polyethylene as described herein is known in the art as such and is commercially available. The skilled person also knows in view of its common knowledge how to make such materials.

### 1.9 the Additives

The composite material is obtainable using additives as the component (g). The additives are provided in an amount in the range of from 0.1 to 5.0 wt.-%, preferably from 0.5 to 5.0 wt.-%, more preferably from 1.0 to 5.0 wt.-%, and even more preferably from 2.0 to 5.0 wt.-%, relative to the total weight of the composite material.

Typical additives are acid scavengers, antioxidants, colorants, (UV) light stabilisers, plasticizers, slip agents, anti-scratch agents, mold release agents, nucleating agents, dispersing agents, processing aids, lubricants, pigments, and the like. In one embodiment, the additives are selected from the group consisting of acid scavengers, antioxidants, colorants, (UV) light stabilisers, plasticizers, slip agents, anti-scratch agents, mold release agents, nucleating agents, dispersing agents, processing aids, lubricants and pigments. Such additives are commercially available and for example described in “Plastic Additives Handbook”, 6th edition 2009 of Hans Zweifel (pages 1141 to 1190).

Typically, the additives being present in the composite material comprise one or more antioxidants. The one or more antioxidants being part of the additives may be present in an amount in the range of 0.02 to 1.5 wt. %, 0.1 to 1.2 wt. %, 0.1 to 1.0 wt. %, based on the total weight of the composite material.

In one embodiment, the additives being present in the composite material comprise one or more pigments. The one or more pigments being part of the additives may be present in an amount in the range of 0.1 to 1.5 wt. %, 0.1 to 1.0 wt. %, 0.1 to 0.5 wt. %, based on the total weight of the composite material.

In one embodiment, the additives being present in the composite material comprise one or more processing aids. The one or processing aids being part of the additives may be present in an amount of 0.5 to 3.0 wt. %, 1.0 to 3.0 wt. %, or 1.5 to 2.5 wt. %, based on the total weight of the composite material. The one or more processing aids may be a siloxane polymer, preferably an ultra-high molecular weight (UHMW) siloxane polymer, or a reaction product thereof obtained by reactive dispersion in a propylene polymer, like a propylene homopolymer carrier resin of a masterbatch. The siloxane polymer may be present in combination with one or more further processing aids.

In one embodiment, the additives being present in the composite material comprise one or more antioxidants, one or more UV stabilizer, one or more pigments, and one or more processing aids. The types of additives may be present in the composite material in the above described amounts.

Furthermore, the additives may include carrier materials, in particular polymeric carrier materials. Said polymeric carrier material may be part of an additives masterbatch. Thus, the additives as component (g) may be provided in form of an additive masterbatch comprising additives and polymeric carrier materials. The polymeric carrier material may ensure a good distribution of the additives in the composite material during preparation, e.g., by melt compounding. The polymeric carrier material is not limited to a particular polymer. The polymeric carrier material may be ethylene homopolymer, ethylene copolymer obtained from ethylene and α-olefin comonomer such as C3 to C8 α-olefin comonomer, propylene homopolymer and/or propylene copolymer obtained from propylene and α-olefin comonomer such as ethylene and/or C4 to C8 α-olefin comonomer.

A large variety of commercial additive masterbatches, including masterbatches comprising one or more of the above-described additives, are available in the art. A skilled person also knows how to prepare an additive masterbatch, e.g., by compounding a carrier polymer with one or more additives of choice.

### 2. Injection Molded Article

Another aspect of the present invention provides an injection molded article comprising the composite material as defined herein.

The injection molded article may comprise at least 60 wt.-%, more preferably at least 80 wt.-%, still more preferably at least 90 wt.-%, like at least 95 wt.-% or at least 99 wt.-%, of the composite material as defined herein, based on the total weight of the injection molded article. In one particular embodiment, the injection molded article essentially consists of or consists of the composite material.

Preferably, the injection molded article is for manufacturing applications, like automotive manufacturing. Thus, it is preferred that the injection molded article is an injection molded automotive article.

In the following, the present invention is described by specific examples, which are however not to be understood as limiting the invention in any way.

### 3. Experimental Section

### 3.1 Measuring Methods

The properties of the starting materials and composite materials were determined using the following measuring methods. The measuring methods also apply for the above general description unless otherwise defined.

### 3.1.1 Melt Flow Rate (MFR)

The melt flow rates MFR₂ were measured according to ISO 1133 with a load of 2.16 kg at 230° C. or 190° C. as indicated in parenthesis for the defined parameter. The melt flow rate is that quantity of polymer in grams which the test apparatus standardized to ISO 1133 extrudes within 10 minutes at a temperature of 230° C., respectively 190° C., under a load of 2.16 kg.

### 3.1.2 CRYSTEX QC Analysis (Crystalline and Soluble Fractions Method)

The crystalline (CF) and soluble fractions (SF) of polypropylene compositions as well as the comonomer content and intrinsic viscosities of the respective fractions were analyzed by use of the CRYSTEX instrument, Polymer Char (Valencia, Spain). Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596).

The crystalline and amorphous fractions were separated through temperature cycles of dissolution at 160° C., crystallization at 40° C. and re-dissolution in 1,2,4-trichlorobenzene at 160° C. Quantification of SF and CF and determination of ethylene content (C2) were achieved by means of an integrated infrared detector (IR4) and for the determination of the intrinsic viscosity (IV) an online 2-capillary viscometer was used. The IR4 detector was a multiple wavelength detector measuring IR absorbance at two different bands (CH3 stretching vibration (centred at app. 2960 cm⁻¹) and the CH stretching vibration (2700-3000 cm⁻¹) that are serving for the determination of the concentration and the Ethylene content in Ethylene-Propylene copolymers. The IR4 detector was calibrated with series of 8 EP copolymers with known Ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b * Abs ( CH ) + c * {( Abs ( CH ) )}^{2} + d * Abs ( {CH}_{3} ) + e * ( Abs {( {CH}_{3} )}^{2} + f * Abs ( CH ) * Abs ( {CH}_{3} ) \qquad ( Equation 1 )$$

$${CH}_{3} / 1000 C = a + b * Abs ( CH ) + c * Abs ( {CH}_{3} ) + d * ( Abs ( {CH}_{3} ) / Abs ( CH ) ) + e * {( Abs ( {CH}_{3} ) / Abs ( CH ) )}^{2} \qquad ( Equation 2 )$$

The constants a to e for equation 1 and a to f for equation 2 were determined by using least square regression analysis.

The CH₃/1000C was converted to the ethylene content in wt.-% using following relationship:

$$Wt . - \% ( Ethylene in EP Copolymers ) = 100 - {CH}_{3} / 1000 C * 0.3 \qquad ( Equation 3 )$$

Amounts of Soluble Fraction (SF) and Crystalline Fraction (CF) were correlated through the XS calibration to the “Xylene Cold Soluble” (XCS) quantity and respectively Xylene Cold Insoluble (XCI) fractions, determined according to standard gravimetric method as per ISO16152. XS calibration was achieved by testing various EP copolymers with XS content in the range 2-31 wt.-%. The determined XS calibration was linear:

$$Wt . - \% XS = 1 , 01 * Wt . - \% SF \qquad ( Equation 4 )$$

Intrinsic viscosity (IV) of the parent EP copolymer and its soluble and crystalline fractions were determined with a use of an online 2-capillary viscometer and were correlated to corresponding IV's determined by standard method in decalin according to ISO 1628-3. Calibration is achieved with various EP PP copolymers with IV=2-4 dL/g. The determined calibration curve was linear:

$$IV ( dL / g ) = a * Vsp / c \qquad ( Equation 5 )$$

The samples to be analyzed were weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0.077/D 0.05 mmm.

After automated filling of the vial with 1,2,4-TCB containing 250 mg/l 2,6-tert-butyl-4-methylphenol (BHT) as antioxidant, the sample was dissolved at 160° C. until complete dissolution was achieved, usually for 60 min, with constant stirring of 400 rpm. To avoid sample degradation, the polymer solution was blanketed with the N₂ atmosphere during dissolution. A defined volume of the sample solution was injected into the column filled with inert support where the crystallization of the sample and separation of the soluble fraction from the crystalline part was taking place. This process was repeated two times. During the first injection the whole sample was measured at high temperature, determining the IV[dl/g] and the C2[wt.-%] of the PP composition. During the second injection the soluble fraction (at low temperature) and the crystalline fraction (at high temperature) with the crystallization cycle were measured (wt.-% SF, wt.-% C₂, IV).

### 3.1.3 Intrinsic Viscosity

The intrinsic viscosity (IV) was measured according to DIN ISO 1628/1, October 1999, in Decalin at 135° C.

### 3.1.4 Xylene Cold Solubles (XCS)

The xylene soluble fraction at room temperature (XCS, wt.-%): the amount of the polymer soluble in xylene was determined at 25° C. according to ISO 16152; 5th edition; 2005 Jul. 1.

### 3.1.5 Density

The density was measured according to ISO 1183-187. Samples were measured on injection molded dogbone specimens of 4 mm thickness prepared in accordance with EN ISO 1873-2.

### 3.1.6 Charpy Notched Impact Strength (NIS)

The Charpy notched impact strength (NIS) was measured according to ISO 179 1 eA at +23° C. or −20° C., using injection molded bar test specimens of 80×10×4 mm³ prepared in accordance with ISO 19069-2 using a melt temperature of 230° C. for all materials irrespective of material melt flow rate.

### 3.1.7 Melting Temperature (Tm) and Crystallization Temperature (T_{c})

Melting temperature (Tm) and crystallization temperature (Tc) were measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature (Tc) and crystallization enthalpy (Hc) were determined from the cooling step, while melting temperature (Tm) and melting enthalpy (Hm) were determined from the second heating step.

### 3.1.8 Flexural Properties

The flexural modulus and the flexural strength were determined according to ISO 178 method A (3-point bending test) on 80 mm×10 mm×4 mm specimens. Following the standard, a test speed of 2 mm/min and a span length of 16 times the thickness was used. The testing temperature was 23±2° C. Injection molding was carried out according to ISO 19069-2 using a melt temperature of 230° C. for all materials irrespective of material melt flow rate.

### 3.1.9 Tensile Properties

Tensile properties were determined on injection molded dogbone specimens of 4 mm thickness prepared in accordance with EN ISO 1873-2. Tensile modulus was determined according to ISO 527-1A at a strain rate of 1 mm/min and 23° C., tensile strength and elongation (strain) at break were determined according to ISO 527-2 at a strain rate of 50 mm/min and 23° C.

### 3.1.10 Fiber Dimension Analysis

The dimension of the cellulose-containing fibers was determined prior to compounding, i.e., prior to preparing the composite material. Weight average fiber length and fiber length distribution were determined according to the FASEP (FAser (German; fiber) SEParation) method. The fibers were suspended in ethanol and the suspension was diluted until the number of fibers and the overlaying of fibers was well balanced. In that regard, a fiber to water fraction was adjusted to equal or below 15 mg/L to obtain images with a number of fiber clusters being below 20% in relation to all fibers. The average fiber length was determined by grey scale image processing on a FASEP 1.9.44.0 (IDM Systems, Darmstadt, Germany) and statistically investigated by calculating average fiber length and fiber length distributions. For evaluation of the images, the FASEP software (ImageProPlus including FASEP module) was used separating fibers from background, removing dust (i.e. particles below 10 μm) and other not relevant features, separating fibers (if overlaying) and measuring automatically the length for each fiber.

The average fiber length Ln and weight average fiber length Lp was determined according to ISO 22314:05:2006 using the following equations A to C:

$$Lp = \frac{\overline{{L}^{2}}}{\overline{L}} \qquad ( Equation A )$$

$$Ln = \frac{1}{{n}_{i}} {{\sum }_{i = 1}}^{n} {L}_{i} \qquad ( Equation B )$$

$$\overline{{L}^{2}} = \frac{1}{{n}_{i}} {{\sum }_{i = 1}}^{n} {L}_{i}^{2} . \qquad ( Equation C )$$

Average diameter values were calculated in an analogous way allowing a calculation of an number-based or weight-based average aspect ratio.

### 3.1.11 Limonene Detection

Limonene quantification is carried out using solid phase microextraction (HS-SPME-GC-MS) by standard addition. 50 mg ground samples are weighed into 20 mL headspace vials and after the addition of limonene in different concentrations and a glass-coated magnetic stir bar, the vial is closed with a magnetic cap lined with silicone/PTFE. Micro capillaries (10 μL) are used to add diluted limonene standards of known concentrations to the sample. Addition of 0, 2, 20 and 100 ng equals 0 mg/kg, 0.1 mg/kg, 1 mg/kg and 5 mg/kg limonene, in addition standard amounts of 6.6 mg/kg, 11 mg/kg and 16.5 mg/kg limonene is used in combination with some of the samples tested in this application. For quantification, ion-93 acquired in SIM mode is used. Enrichment of the volatile fraction is carried out by headspace solid phase microextraction with a 2 cm stable flex 50/30 μm DVB/Carboxen/PDMS fiber at 60° C. for 20 minutes. Desorption is carried out directly in the heated injection port of a GCMS system at 270° C.

### GCMS Parameters:

Column: 30 m HP 5 MS 0.25*0.25
Injector: Splitless with 0.75 mm SPME Liner, 270° C.
Temperature program: −10° C. (1 min)
Carrier gas: Helium 5.0, 31 cm/s linear velocity, constant flow
MS: Single quadrupole, direct interface, 280° C. interface temperature
Acquisition: SIM scan mode
Scan parameter: 20-300 amu
SIM Parameter: m/Z 93, 100 ms dwell time

### 3.2 Starting Materials

The following components were used as starting materials to prepare the composite materials:

### 3.2.1 Synthesis of Heterophasic Propylene-Ethylene Copolymers (HECOs)

The catalyst used for producing HECO1 was a Ziegler-Natta catalyst commercially available from Lyondell Basell (IT), under the trade name ZN180M.

The catalyst used for producing HECO2 was a Ziegler-Natta catalyst from Borealis having Ti-content of 1.9 wt.-% (as described in EP 0 591 224). Before the polymerization, the catalyst was prepolymerized with vinyl-cyclohexane (VCH) as described in EP 1 028 984 and EP 1 183 307. The ratio of VCH to catalyst of 1:1 was used in the preparation, thus the final poly-VCH content was less than 100 ppm. In the first stage the catalyst described above was fed into prepolymerization reactor together with propylene and small amount of hydrogen (2.5 g/h) and ethylene (330 g/h). Triethylaluminium as a cocatalyst and dicyclopentyldimethoxysilane as a donor was used. The aluminium to donor ratio was 7.5 mol/mol and aluminium to titanium ratio was 300 mol/mol. Reactor was operated at a temperature of 30° C. and a pressure of 55 bar. The subsequent polymerization has been effected under the conditions as described in Table 1 below.

TABLE 1
Polymerization conditions for the HECOs

| | | HECO1 | HECO2 |
|---|---|---|---|
| Co/ED | [mol/mol] | 10 | 6 |
| Co/Ti | [mol/mol] | 220 | 200 |
| Temperature | [° C.] | 30 | 30 |
| Residence time | [min] | 5 | 15 |
| Loop reactor | | | |
| Temperature | [° C.] | 75 | 85 |
| Split | [wt.-%] | 52 | 35 |
| H2/C3 | [mol/kmol] | 22.00 | 65.0 |
| MFR₂ | [g/10 min] | 160 | 140 |
| 1^{st} Gas phase reactor | | | |
| Temperature | [° C.] | 80 | 85 |
| Split | [wt.-%] | 34 | 40 |
| H2/C3 | [mol/kmol] | 175.0 | 21.2 |
| MFR₂ | [g/10 min] | 160 | 55 |
| MFR(GPR1) | [g/10 min] | 160 | 30 |
| XCS | [wt.-%] | 2.0 | 1.9 |
| 2^{nd} Gas phase reactor | | | |
| Temperature | [° C.] | 80 | 70 |
| C2/C3 | [mol/kmol] | 550.0 | 210.0 |
| H2/C2 | [mol/kmol] | 250.0 | 15.0 |
| Split | [wt.-%] | 14 | 15 |
| C2 | [wt.-%] | 99.0 | 4.5 |
| MFR₂ | [g/10 min] | 100 | 20 |
| 3^{rd} Gas phase reactor | | | |
| Temperature | [° C.] | — | 85 |
| C2/C3 | [mol/kmol] | — | 210.0 |
| H2/C2 | [mol/kmol] | — | 10.0 |
| Split | [wt.-%] | — | 10 |
| C2 | [wt.-%] | — | 7 |
| MFR₂ | [g/10 min] | — | 5.5 |

Table 2 shows the properties of HECO1 and HECO2.

TABLE 2

| | | HECO1 | HECO2 |
|---|---|---|---|
| Pellet | | | |
| XCS | [wt.-%] | 15 | 22.7 |
| C2(XCS) | [wt.-%] | 54 | 22.6 |
| iV(XCS) | [dl/g] | 2.0 | 6.2 |
| MFR₂ | [g/10 min] | 100 | 5.5 |
| Tm | [° C.] | 165 | 166 |
| Tc | [° C.] | 121 | 115 |
| CRYSTEX analysis | | | |
| SF | [wt.-%] | 14.7 | 21.8 |
| C2 | [wt.-%] | 8.0 | 7.0 |
| C2(SF) | [wt.-%] | 39.5 | 23.3 |
| C2(CF) | [wt.-%] | 2.4 | 2.9 |
| IV | [dl/g] | 1.5 | 3.4 |
| IV(SF) | [dl/g] | 2.1 | 5.6 |
| IV(CF) | [dl/g] | 1.2 | 2.2 |
| IV(SF)/IV(CF) | — | 2.6 | 2.5 |
| Mechanical properties | | | |
| Flex. modulus | [MPa] | 1400 | 1050 |
| Charpy NIS 23° C. | [kJ/m²] | 3.2 | 48 |
| Charpy NIS −20° C. | [kJ/m²] | 1.8 | 6.3 |

The heterophasic copolymers HECO1 and HECO2 were compounded in a co-rotating twin-screw extruder Coperion ZSK 47 at 220° C. with 0.15 wt.-% antioxidant (Irganox B215FF from the company BASF AG, Germany; this is a 1:2-mixture of Pentaerythrityl-tetrakis(3-(3′,5′-di-tert. butyl-4-hydroxyphenyl)-propionate, CAS-no. 6683-19-8, and Tris(2,4-di-t-butylphenyl)phosphite, CAS-no. 31570 April 4) and 0.05 wt.-% of Ca-stearate (CAS-no. 1592-23-0, commercially available from Faci, Italy).

### 3.2.2 Mixed Plastic Polypropylene Blend

Two post-consumer recyclate polypropylene (PCR-PP) blends PCR-PP1 and PCR-PP2 were used as the mixed plastic polypropylene blend for preparing the composite materials. The properties are described herein below in table 3:

TABLE 3

| | | PCR-PP1 | PCR-PP2 |
|---|---|---|---|
| MFR₂ | [g/10 min] | 26 | 18 |
| C2(total) | [wt.-%] | 6.6 | 5.3 |
| SF | [wt.-%] | 10.8 | 10.0 |
| C2(SF) | [wt.-%] | 27.8 | 26.5 |
| iV(SF) | [dL/g] | 1.74 | 1.79 |
| CF | [wt.-%] | 89.2 | 90.0 |
| C2(CF) | [wt.-%] | 3.8 | 2.9 |
| iV(CF) | [dL/g] | 1.64 | 1.69 |
| Limonene content | [ppm] | >0.1 | >0.1 |

### 3.2.3 Ethylene-Based Elastomer

Ethylene-1-octene elastomer, commercially available under the tradename “Engage 8842” from the company Dow Chemical, having a density of about 857 kg/m³ and a melt flow rate MFR (190° C.; 2.16 kg) of 1.0 g/10 min. It is further characterized by a content of units derived from 1-octene of about 45 wt.-% and a melting temperature of 38° C.

### 3.2.4 Cellulose-Containing Fibers

Softwood fibers, commercially available under the tradename “Arbocel C400” from “Rettenmaier & Söhne”, weight-based average length of 820 μm (according to FASEP analysis) and a weight-based aspect ratio of 2.5 (according to FASEP analysis).

### 3.2.5 Compatibilizer

Polypropylene functionalized with maleic anhydride, commercially available under the tradename “SCONA TPPP 8112 GA” by the company BYK Kometra, having a maleic anhydride content of 1.4 wt.-% and an MFR (ISO1133, 230° C., 2.16 kg) about 80 g/10 min.

### 3.2.6 High Density Polyethylene (HDPE)

High density polyethylene (HDPE) was a commercial grade having a density of 954 kg/m³ (ISO 1183), MFR₂ (ISO1133, 190° C., 2.16 kg) of 4 g/10 min and a tensile modulus of 850 MPa (ISO 527-2).

### 3.2.7 Additives

ADD1: polyethylene based masterbatch containing black pigment.
ADD2: polypropylene based masterbatch containing 50 wt.-% of ultra-high molecular weight siloxane polymer, with tradename MB50-001 commercially available from Dow Corning.
ADD3: ADK Stab LA-408X, synergistic UV stabilizer masterbatch, commercially available from Adeka, France.
ADD4: antioxidant with a tradename of Irganox 1010 (pentaerythrityl-tetrakis(3-(3′,5′-di-tert. butyl-4-hydroxyphenyl)-propionate, CAS-no. 6683-19-8), commercially available from BASF AG.
ADD5: antioxidant with a trade name of Irgafos 168 (tris(2,4-di-t-butylphenyl)phosphite, CAS-no. 31570-04-4), available from BASF AG.
ADD6: propylene homopolymer carrier resin for masterbatch, commercially available grade “HC001” from Borealis AG.

### 3.3 Examples of Composite Materials

Composite materials IE1 to IE4 and CE1 to CE4 were prepared based on the formulation recipes shown in tables 4a and 4b provided herein below.

TABLE 4a

| Example no. | | IE1 | IE2 | CE1 | CE2 |
|---|---|---|---|---|---|
| Components | | | | | |
| HECO1 | [wt.-%] | 26.8 | 17.6 | 36 | 39 |
| HECO2 | [wt.-%] | 18 | 12 | 24 | 24 |
| HDPE | [wt.-%] | 9.5 | 9.5 | 9.5 | 9 |
| Elastomer | [wt.-%] | 11.2 | 12.4 | 10 | 10 |
| Compatibilizer | [wt.-%] | 3 | 3 | 3 | 3 |
| Additives | | | | | |
| ADD1 | [wt.-%] | 0.1 | 0.1 | 0.1 | — |
| ADD2 | [wt.-%] | 2 | 2 | 2 | — |
| ADD3 | [wt.-%] | 0.2 | 0.2 | 0.2 | — |
| ADD4 | [wt.-%] | 0.1 | 0.1 | 0.1 | — |
| ADD5 | [wt.-%] | 0.1 | 0.1 | 0.1 | — |
| ADD6 | [wt.-%] | — | — | — | — |
| Mixed-plastic blend | | | | | |
| PCR-PP1 | [wt.-%] | 14 | 28 | — | — |
| PCR-PP2 | [wt.-%] | — | — | — | — |
| Fibers | [wt.-%] | 15 | 15 | 15 | 15 |

TABLE 4b

| Example no. | | IE3 | IE4 | CE3 | CE4 |
|---|---|---|---|---|---|
| Components | | | | | |
| HECO1 | [wt.-%] | 13.9 | 13.9 | 33.8 | 33.7 |
| HECO2 | [wt.-%] | 10.8 | 10.8 | 24 | 24 |
| HDPE | [wt.-%] | 9.5 | 9.5 | 9.5 | 9.5 |
| Elastomer | [wt.-%] | 12.5 | 12.5 | 10 | 10 |
| Compatibilizer | [wt.-%] | 3 | 3 | 3 | 3 |
| Additives | | | | | |
| ADD1 | [wt.-%] | 0.1 | 0.1 | — | 0.1 |
| ADD2 | [wt.-%] | 2 | 2 | 2 | 2 |
| ADD3 | [wt.-%] | 0.2 | 0.2 | 0.2 | 0.2 |
| ADD4 | [wt.-%] | 0.1 | 0.1 | 0.1 | 0.1 |
| ADD5 | [wt.-%] | 0.1 | 0.1 | 0.1 | 0.1 |
| ADD6 | [wt.-%] | 1.3 | 1.3 | 1.3 | 1.3 |
| Mixed-plastic blend | | | | | |
| PCR-PP1 | [wt.-%] | 30.5 | — | — | — |
| PCR-PP2 | [wt.-%] | — | 30.5 | — | — |
| Fibers | [wt.-%] | 16 | 16 | 16 | 16 |

Composite materials IE1 to IE4 and CE1 to CE4 were obtained by melt-blending the components shown in tables 4a and 4b in a twin screw extruder with soft mixing elements at temperatures of 180-200° C.

The properties of the composite materials are shown in tables 5a and 5b. The polymeric part of the composite materials was analyzed by CRYSTEX QC analysis as described herein above, wherein the weight amounts in [wt.-%] are relative to the total weight of the polymeric part of the composite material or, where applicable, relative to the total weight of the soluble fraction (SF) and crystalline fraction (CF), respectively.

TABLE 5a

| Example no. | | IE1 | IE2 | CE1 | CE2 |
|---|---|---|---|---|---|
| MFR | [g/10 min] | 11 | 10.5 | 11.8 | 12.2 |
| Mechanical properties | | | | | |
| Density | [kg/m³] | 964 | 965 | 962 | 964 |
| Tensile modulus | [MPa] | 1638 | 1584 | 1637 | 1659 |
| Tensile strength | [MPa] | 23.5 | 22.5 | 23.2 | 23.6 |
| Flexural modulus | [MPa] | 1440 | 1394 | 1441 | 1504 |
| Flexural strength | [MPa] | 30.7 | 29.8 | 30.6 | 32.1 |
| Charpy NIS 23° C. | [kJ/m²] | 15.0 | 14.6 | 14.3 | 14.0 |

TABLE 5b

| Example no. | | IE3 | IE4 | CE3 | CE4 |
|---|---|---|---|---|---|
| MFR | [g/10 min] | 11.2 | 11.0 | 14.3 | 14.0 |
| CRYSTEX | | | | | |
| QC analysis | | | | | |
| C2 total [wt.-%]* | [wt.-%] | 26.8 | 26.4 | 24.2 | 23.4 |
| SF [wt.-%]* | [wt.-%] | 26.2 | 26.5 | 26.9 | 25.9 |
| CF [wt.-%]* | [wt.-%] | 73.8 | 73.5 | 73.1 | 74.1 |
| C2(SF) [wt.-%]** | [wt.-%] | 51.7 | 59.0 | 50.9 | 50.5 |
| C2(CF) [wt.-%]** | [wt.-%] | 18.8 | 19.0 | 15.9 | 16.8 |
| IV total [dl/g] | [dl/g] | 1.8 | 1.8 | 1.8 | 1.8 |
| IV(SF) [dl/g] | [dl/g] | 2.3 | 2.3 | 2.6 | 2.7 |
| IV(CF) [dl/g] | [dl/g] | 1.7 | 1.7 | 1.6 | 1.6 |
| Mechanical properties | | | | | |
| Tensile modulus | [MPa] | 1579 | 1585 | 1691 | 1682 |
| Tensile strength | [MPa] | 22.9 | 23.0 | 23.5 | 23.5 |
| Flexural modulus | [MPa] | 1538 | 1532 | 1653 | 1615 |
| Flexural strength | [MPa] | 28.0 | 28.1 | 30.3 | 29.9 |
| Charpy NIS 23° C. | [kJ/m²] | 15.6 | 15.2 | 15.0 | 14.5 |
| Charpy NIS −20° C. | [kJ/m²] | 4.4 | 4.0 | 4.0 | 4.4 |

*relative to the total weight of the polymeric part of the composite material
**relative to the total weight of the respective fraction

As can be seen from the data shown in tables 5a and 5b, the inventive composite materials IE1 to IE4 provide a good balance of stiffness (flexural properties) and strength (tensile properties) on the one hand and high impact strength (Charpy NIS) on the other hand. The properties are comparable to those of comparative materials CE1 to CE4 which do not contain post-consumer recyclates PCR-PP1 or PCR-PP2. Thus, composite materials IE1 to IE4 contain renewable wood fiber and recycling material while still achieving desired properties, e.g., for automotive construction.

1. A composite material being obtainable by blending the components (a) to (g), and optionally component (h):
(a) from 10.0 to 35.0 wt. % of a first heterophasic propylene-ethylene copolymer (HECO1) having a melt flow rate (MFR₂), determined according to ISO 1133 at 230° C. and 2.16 kg, in the range from 60 to 200 g/10 min,
(b) from 5.0 to 25.0 wt. % of a second heterophasic propylene-ethylene copolymer (HECO2) having:
a melt flow rate (MFR₂), determined according to ISO 1133 at 230° C. and 2.16 kg, in the range from 4 to 30 g/10 min, and
a soluble fraction (SF), determined according to CRYSTEX QC analysis, in the range from 17.0 to 40.0 wt. %, relative to the total weight of the second heterophasic propylene-ethylene copolymer (HECO2),
(c) from 8.0 to 40.0 wt. % of a mixed-plastic polypropylene blend having a polypropylene content of at least 75 wt. %, based on the total weight of the mixed-plastic polypropylene blend;
(d) from 8.0 to 18.0 wt. % of an ethylene-based elastomer being a copolymer of ethylene and an alpha-olefin co-monomer having from 4 to 12 carbon atoms, and the ethylene-based elastomer having a density in the range of 850 to 900 kg/m³,
(e) from 5.0 to 30.0 wt. % of cellulose-containing fibers,
(f) from 1.0 to 5.0 wt. % of a compatibilizer being a polar modified polypropylene or a polar modified elastomer,
(g) from 0.1 to 5.0 wt. % of additives,
(h) optionally from 0.1 to 15.0 wt. % of a high density polyethylene, wherein the weight amounts of components (a) to (h) are defined relative to the total weight of the composite material.

2. The composite material according to claim 1, having
a melt flow rate (MFR₂), determined according to ISO 1133 at 230° C. and 2.16 kg, in the range from 8 to 80 g/10 min.

3. The composite material according to claim 1, having the following characteristics:
a flexural modulus, determined according to ISO 178, of at least 1100 MPa; and
a Charpy Notched impact strength at 23° C., determined according to ISO 179 1 eA, of at least 7.0 kJ/m².

4. The composite material according to claim 1, being obtainable by blending the components (a) to (h):
(a) from 11.0 to 32.0 wt. % of the first heterophasic propylene-ethylene copolymer (HECO1),
(b) from 7.0 to 23.0 wt. % of the second heterophasic propylene-ethylene copolymer (HECO2),
(c) from 10.0 to 37.0 wt. % of the mixed-plastic polypropylene blend,
(d) from 9.0 to 17.0 wt. % of the ethylene-based elastomer,
(e) from 8.0 to 28.0 wt. % of the cellulose-containing fibers,
(f) from 1.0 to 5.0 wt. % of the compatibilizer,
(g) from 0.5 to 5.0 wt. % of the additives,
(h) from 1.0 to 15.0 wt. % the high density polyethylene,
wherein the weight amounts are relative to the total weight of the composite material, and optionally wherein the weight amounts add up to at least 98.0 wt. %.

5. The composite material according to claim 1, the first heterophasic propylene-ethylene copolymer (HECO1) having one or both of the following characteristics:
a soluble fraction (SF) content, determined according to CRYSTEX QC analysis, in the range from 6.0 to 22.0 wt. %, relative to the total weight of the first heterophasic propylene-ethylene copolymer (HECO1); and
an intrinsic viscosity, determined according to DIN ISO 1628/1, of the soluble fraction content (iV(SF)), according to CRYSTEX QC analysis, in the range from 1.5 to 3.5 dL/g.

6. The composite material according to claim 1, the second heterophasic propylene-ethylene copolymer (HECO2) having one or both of the following characteristics:
a melt flow rate (MFR₂), determined according to ISO 1133 at 230° C. and 2.16 kg, in the range from 4 to 25 g/10 min, preferably from 4 to 20 g/10 min, and more preferably from 5 to 15 g/10 min; and
an intrinsic viscosity, determined according to DIN ISO 1628/1, of the soluble fraction content (iV(SF)), according to CRYSTEX QC analysis, in the range from 2.0 to 7.0 dL/g.

7. The composite material according to claim 1, the second heterophasic propylene-ethylene copolymer (HECO2) having at least one of the following characteristics:
a soluble fraction (SF), determined according to CRYSTEX QC analysis, in the range from 18.0 to 38.0 wt. %, relative to the total weight of the second heterophasic propylene-ethylene copolymer (HECO2);
a soluble fraction (SF) having an ethylene content (C2(SF)) determined by FT-IR spectroscopy calibrated by quantitative ¹³C-NMR spectroscopy, in the range from 20.0 to 50.0 wt. %, relative to the total weight of the soluble fraction (SF) of the second heterophasic propylene-ethylene copolymer (HECO2); and
a ratio of the intrinsic viscosity of the soluble fraction content (iV(SF)), according to CRYSTEX QC analysis, to the intrinsic viscosity of the crystalline fraction (iV(CF)), according to CRYSTEX QC analysis, in the range of from 1.2 to 6.0, the intrinsic viscosity being determined according to DIN ISO 1628/1.

8. The composite material according to claim 1, the mixed-plastic polypropylene blend having a limonene content, determined by solid phase microextraction (HS-SPME-GC-MS), of at least 0.10 ppm.

9. The composite material according to claim 1, the mixed-plastic polypropylene blend having at least one of the following characteristics:
a melt flow rate (MFR₂), determined according to ISO 1133 at 230° C. and 2.16 kg, in the range from 2 to 70 g/10 min;
a soluble fraction (SF) content in the range from 4.0 to 16.0 wt. %, relative to the total weight of the mixed-plastic polypropylene blend, and a crystalline fraction (CF) content in the range from 84.0 to 96.0 wt. %, relative to the total weight of the mixed-plastic polypropylene blend, both fractions determined according to CRYSTEX QC analysis;
a crystalline fraction (CF) having an ethylene content (C2(CF)), determined by FT-IR spectroscopy calibrated by quantitative ¹³C-NMR spectroscopy, in the range from 1.0 to 12.0 wt. %, relative to the total weight of the crystalline fraction (CF) of the mixed-plastic polypropylene blend;
an intrinsic viscosity of the soluble fraction (iV(SF)), according to CRYSTEX QC analysis, determined according to DIN ISO 1628/1, in the range from 0.90 to 2.2 dL/g; and
a polypropylene content in the range of from 80 to 99 wt. %, based on the total weight of the mixed-plastic polypropylene blend.

10. The composite material according to claim 1, the ethylene-based elastomer having a density in the range of 855 to 895 kg/m³, and a melt flow rate (MFR₂), determined according to ISO 1133 at 190° C. and 2.16 kg, in the range from 0.5 to 30 g/10 min.

11. The composite material according to claim 1, the ethylene-based elastomer being a copolymer of ethylene and an alpha-olefin co-monomer having from 4 to 8 carbon atoms.

12. The composite material according to claim 1, the compatibilizer being a polar modified propylene homo- or copolymer, and optionally wherein the polar modified propylene homo- or copolymer is a propylene homo- or copolymer grafted with maleic anhydride and/or acrylic acid.

13. The composite material according to claim 1, the cellulose-containing fibers having
a weight-based average fiber length in the range of 0.10 to 2.0 mm.

14. The composite material according to claim 1, the high density polyethylene having a density in the range of 945 to 965 kg/m³, and optionally having a melt flow rate (MFR₂), determined according to ISO 1133 at 190° C. and 2.16 kg, in the range from 0.5 to 30 g/10 min.

15. An injection molded article comprising, the composite material according to claim 1.

16. The composite material according to claim 1, having a density of less than 1000 kg/m³.

17. The composite material according to claim 1, having the following characteristics:
a flexural modulus, determined according to ISO 178, of at least 1200 MPa; and
a Charpy Notched impact strength at 23° C., determined according to ISO 179 1 eA, of at least 11.0 kJ/m².

18. The composite material according to claim 1, the second heterophasic propylene-ethylene copolymer (HECO2) having:
a melt flow rate (MFR₂), determined according to ISO 1133 at 230° C. and 2.16 kg, in the range from 4 to 20 g/10 min; and
an intrinsic viscosity, determined according to DIN ISO 1628/1, of the soluble fraction content (iV(SF)), according to CRYSTEX QC analysis, in the range from 2.5 to 6.8 dL/g.

19. The composite material according to claim 1, wherein the mixed-plastic polypropylene blend is a recycled material.

20. The composite material according to claim 1, the cellulose-containing fibers having a weight-based average aspect ratio of at least 1.5.
